(19) United States
(12) Patent Application Publication
(10) Pub. No.: US 2006/0100787 A1
(43) Pub. Date: May 11, 2006

(54) Synthesis of nanocodes, and imaging using scanning probe microscopy

(75) Inventors: Andrew A. Berlin, San Jose, CA (US); Joseph V. Kosmoski, Cathedral City, CA (US); Narayanan Sundararajan, San Francisco, CA (US); Xing Su, Cupertino, CA (US); Mineo Yamakawa, Campbell, CA (US)

Correspondence Address: DLA PIPER RUDNICK GRAY CARY US, LLP, 4365 EXECUTIVE DRIVE, SUITE 1100, SAN DIEGO, CA, 92121-2133, US

(73) Assignees: Intel Corporation, Santa Clara, CA (US); Callida Genomics, Inc., Sunnyvale, CA (US)

(21) Appl. No.: 10/985,547

(22) Filed: Nov. 9, 2004

(51) Int. Cl. G06F 19/00

(52) U.S. Cl. 702/19; 702/20

(57) ABSTRACT

Methods for making nanocodes that can be detected using scanning probe microscopy are provided, as are nanocodes constructed of two or more polymers, including homogeneous polymers such as nucleic acid molecules and heterogeneous polymers such as peptide nucleic acid polymers, and subunits useful for constructing such nanocodes. Also provided are modified nanocodes such as a nanocode containing one or more linked metals such as gold or iron and/or a linked probe that can specifically bind a target molecule. In addition, systems are provided that include such nanocodes, for example, a system that includes the nanocode and a surface and/or a scanning probe microscope probe. Methods of using such nanocodes, for example, to detect and/or identify a target molecule in a sample (e.g., a biological or environmental sample) using scanning probe microscopy, also are provided.

### BACKGROUND OF THE INVENTION

1. Field of the Invention

The invention relates generally to detection and analysis of macromolecules, and more specifically to detection and analysis of macromolecules using scanning probe microscopy of molecular barcodes (nanocodes).

2. Background Information

Detection and/or identification of biomolecules are of use for a variety of applications in medical diagnostics, forensics, toxicology, pathology, biological warfare, public health and numerous other fields. Although the principle classes of biomolecules studied are nucleic acids and proteins, examination of other biomolecules such as carbohydrates, lipids, polysaccharides, fatty acids and others also can be informative. A need exists for rapid, reliable and cost effective methods of identification of biomolecules, methods of distinguishing between similar biomolecules and of analyzing macromolecular complexes such as pathogenic spores or microorganisms.

Standard methods for nucleic acid detection, such as Southern blotting, northern blotting or binding to nucleic acid chips, rely on hybridization of a fluorescent, chemiluminescetit or radioactive probe molecule with a target nucleic acid molecule. In oligonucleotide hybridization-based assays, a labeled oligonucleotide probe that is complementary in sequence to a target nucleic acid is used to bind to and detect the nucleic acid. More recently, DNA (deoxyribonucleic acid) chips have been designed that can contain hundreds or thousands of attached oligonucleotide probes for binding to target nucleic acids. Unfortunately, problems with sensitivity and/or specificity may result from nucleic acid hybridization between sequences that are not completely complementary, and the presence of low levels of a target nucleic acid in a sample may not be detected, thus limiting the usefulness of such chip based analysis.

A variety of techniques are available for identifying proteins, polypeptides and peptides. Commonly, these techniques involve binding and detection of antibodies. Although antibody-based identification is fairly rapid, such assays occasionally show high levels of false positives or false negatives. In addition, the cost of performing immunoassays is high, and simultaneous assaying of more than one target can be difficult. Further, the methods require that an antibody be prepared against the target protein of interest before an assay can be performed.

A number of applications in molecular biology, genetics, disease diagnosis and prediction of drug responsiveness involve identification of nucleic acid sequence variants. Existing methods for nucleic acid sequencing, including dideoxy sequencing and sequencing by hybridization, tend to be relatively slow, expensive, and labor intensive, and can involve use of radioactive tags or other toxic chemicals that require special precautions for storage and handling, and must be disposed of as hazardous waste. Existing nucleic acid sequencing methods are also limited as to the amount of sequence information that can be obtained in a single assay, typically less than about 1000 bases. Thus, a need exists for more rapid and cost-effective methods of nucleic acid and other biomolecule analysis, particularly methods suitable to automation.

### BRIEF DESCRIPTION OF THE DRAWINGS

FIG. 1 shows provides a partial sequence (SEQ ID NO: 1) of the pBK-CMV plasmid, which is the original sequence used to construct DNA based nanocodes. A polymerase chain reaction (PCR) primer pair, including a 5′ primer (SEQ ID NO:2) and 3′ primer (SEQ ID NO:3) are shown, with the target sequences in the pBK-CMV sequence indicated in bold print. Letters (A, B, C, etc.) show positions in which additional oligonucleotide sequences were added by oligonucleotide synthesis.

FIG. 2 shows the basic structure of a DNA based nanocode, which contains short branches and long branches 140.

FIG. 3 shows three different nanocode structures, including nanocode PB2A, nanocode PB2B, and nanocode PB2C. Asterisks indicates positions that can be modified (see Example 2; see, also, FIG. 4).

FIG. 4 shows the generation of a nanocode structure (middle panel), which is formed by ligation of subunits (upper panel), and was modified by linking a nanoparticle to form nanocode PB3 (lower panel).

FIG. 5 illustrates the structure of nanocode PB2ex (see Example 1), and the construction of nanocode XPB2.

FIGS. 6A and 6B illustrate the construction of nanocodes containing bubbles, including a nucleic acid-peptide mosaic nanocode (FIG. 6A) and a tetra-stranded nucleic acid nanocode (FIG. 6B).

FIG. 7A illustrates the construction of a branched nanocode.

FIG. 7B illustrates the construction of another branched nanocode.

FIGS. 8A and 8B illustrate scanning probe microscopy surface analysis devices, including a device for performing atomic force microscopy (FIG. 8A) and a device for performing scanning tunneling microscopy (FIG. 8B).

FIGS. 9A to 9C illustrate components of a molecular characterization system.

FIG. 9A shows a diagram of a reaction chamber.

FIG. 9B shows a diagram of a substrate, and molecule assemblies.

FIG. 9C shows a diagram of a surface analysis device and substrate.

FIG. 10 illustrates a processing system.

FIGS. 11A and 11B are a side view and a plan view, respectively, of a MEMS cantilever series switch.

FIG. 12 shows atomic force microscopy (AFM) imaging of a poly-L-lysine coated coverslip containing 50 nm gold particles.

FIGS. 13A and 13B show AFM imaging of AP-mica (FIG. 13A; control) and AP-mica containing 10 nm gold particles (FIG. 13B).

FIGS. 14A to 14C show AFM imaging of nanocode PB2 at concentrations of 100 ng/μl (FIG. 14A), 10 ng/μl (FIG. 14B), and 5 ng/μl (FIG. 14C).

FIG. 15 shows AFM imaging of nanocode PB2 and a 2.8 b linearized plasmid. Inset shows close-up of circled region.

FIG. 16 shows AFM imaging of nanocode PB3B-G at a 1:100 dilution of a 3.5 ng/μl stock solution. Partially labeled individual nanocodes are circled.

### DETAILED DESCRIPTION OF THE INVENTION

Embodiments of the present invention are based, in part, on the development of nucleic acid based nanocodes that can be detected using scanning probe microscopy (SPM). As such, methods of using SPM to detect a molecular probe operably linked to such a nanocode are provided, as are methods of using SPM to detect the presence of a target nucleic acid in a sample by detecting specific binding of such a nanocode tagged molecular probe. In various embodiment, molecular identification systems, which include one or more nanocode tagged molecular probes, also are provided, wherein the molecular probe (and a target molecule bound thereto) can be identified by detecting the surface property of the nanocode. In one embodiment, the molecular identification system includes a solid support (e.g., a wafer, chip, glass slide or bead) to which one or a plurality of same and/or different nanocode tagged molecular probe(s) is (are) immobilized (for example, a plurality of different nanocode tagged molecular probes, which can be arranged in an array (e.g., an addressable array) on the solid support).

As used herein, the term “a” or “an” means one or more than one of an item. As used herein, the term “multiplicity” or “plurality” of an item means two or more of the item or of different items, which can be related (e.g., two or more nanocodes, two or more molecular probes, two or more molecular probes, each of which is operably linked to a nanocode, wherein the nanocodes can be the same or different).

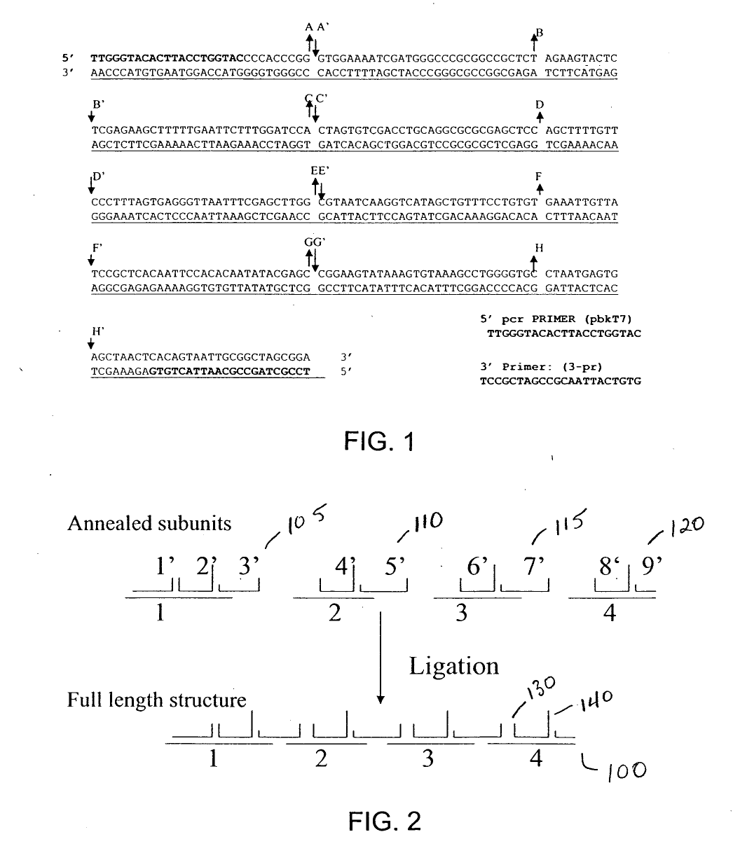

FIG. 1 shows provides a partial sequence (SEQ ID NO: 1) of the pBK-CMV plasmid, which is the original sequence used to construct DNA based nanocodes. A polymerase chain reaction (PCR) primer pair, including a 5′ primer (SEQ ID NO:2) and 3′ primer (SEQ ID NO:3) are shown, with the target sequences in the pBK-CMV sequence indicated in bold print. In various embodiments, nanocodes are branched, contain bubbles, and/or are mosaic structures, and further can provide basic structures that can be combined, for example, by ligation, to produce additional nanocodes.

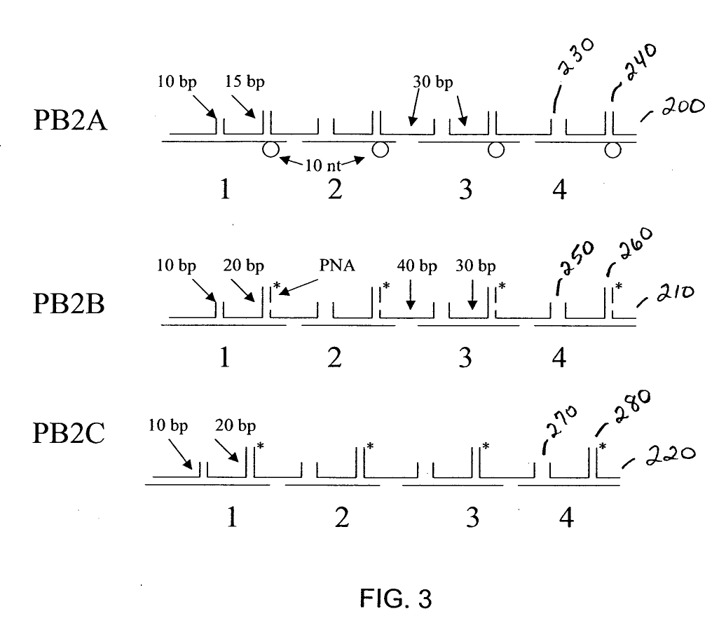

FIG. 2 shows a basic structure of a DNA based nanocode 100, which contains short branches 130 and long branches 140. Four annealed subunits 105, 110, 115, and 120, each formed by hybridization of specific oligonucleotides (1, 2, 3, 4, 1′, 2′, 3′, 4′, 5′, 6′, 7′, 8′, and 9′) are shown in the upper panel, and a full length nanocode 100 structure formed following hybridization and ligation of the subunits is shown in the lower panel. The “spaces” between the oligonucleotides of the “bottom strand” of nanocode 100 (e.g., between oligonucleotides 1 and 2) indicate ligatable sites. Although the spaces are shown to illustrate the relative positions of the subunits, the “bottom strand” oligonucleotides are fully ligated in all nanocode structures (not shown; same for FIGS. 3 to 5).

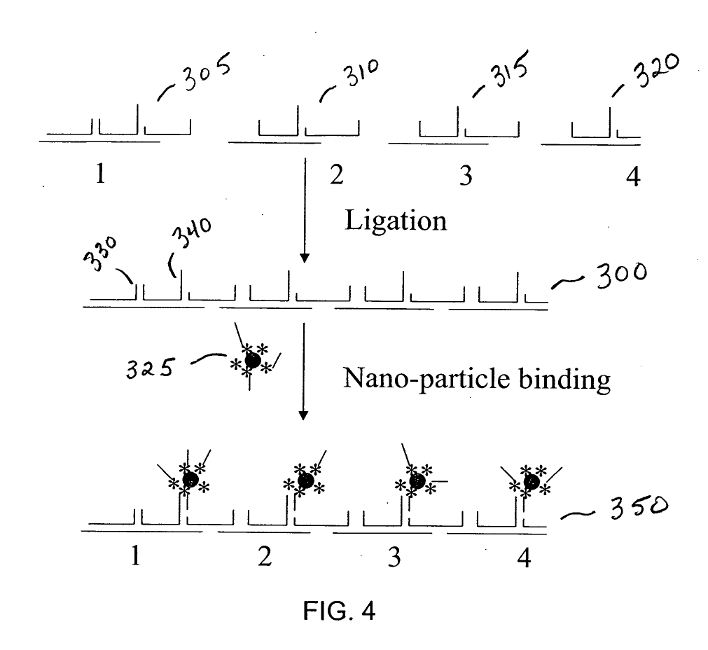

FIG. 3 shows three different nanocode structures, including nanocode 200 (PB2A), which contains shorter branches 230 and longer branches 240; nanocode 210 (PB2B), which contains shorter branches 250 and longer branches 260; and nanocode 220 (PB2C), which contains shorter branches 270 and longer branches 280. Nanocodes 200, 210 and 220 are based on the same general full length structure (“PB2”; see Example 1), and are formed by ligating four subunits 1, 2, 3, and 4. The number of bases in various portions is indicated. Ten nucleotide (“10 nt”) loops formed by single stranded DNA regions in nanocode 200 are indicated. Positions that can be modified are indicated by an asterisk (*; see Example 2, and FIG. 4).

FIG. 4 shows the generation of nanocode structure 300 (middle panel), which is formed by ligation of subunits 305, 310, 315, and 320 (upper panel), and contains shorter branches 330 and longer branches 340. As indicated, nanocode 300 was modified by linking nanoparticle 325 to the longer branches 340 to form nanocode structure 350 (PB3; lower panel).

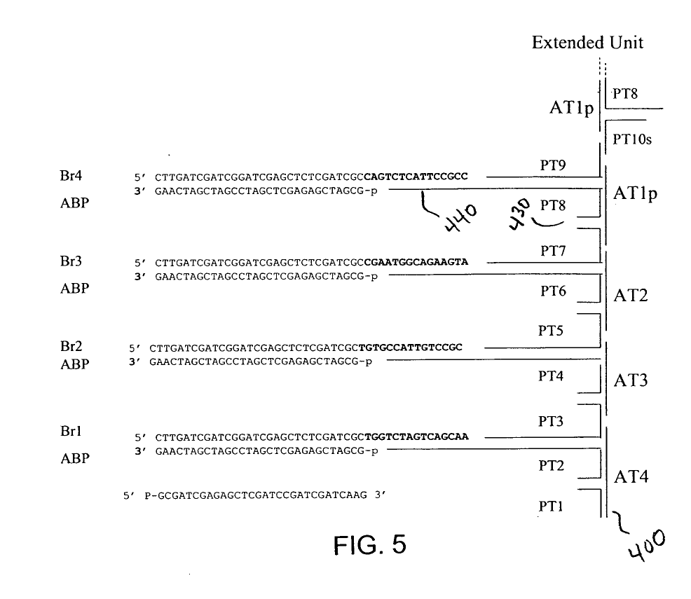

FIG. 5 illustrates the structure of nanocode 400 (PB2ex; see Example 1), which contains shorter branches 430 and longer branches 440. Nanocode 400 (PB2ex) was constructed by modifying PB2 (see, e.g., FIG. 2; nanocode 100) by annealing oligonucleotides Br1, Br2, Br3, and Br4 (SEQ ID NO:4) and oligonucleotide ABP (SEQ ID NO:5) and ligating the product to longer branches 440. Also shown in FIG. 5 is the construction of nanocode XPB2, in which one end of nanocode PB2, AT1p, was modified such that, in the presence of oligonucleotides PT10s and PT8, two full length structures can anneal and be ligated.

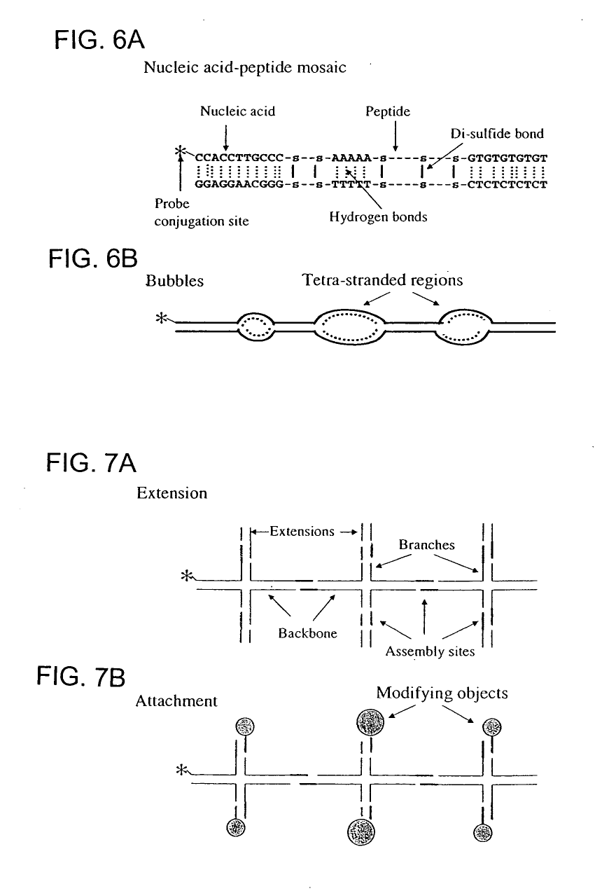

FIGS. 6A and 6B illustrate the construction of nanocodes containing bubbles, including the construction of a nucleic acid-peptide mosaic nanocode (FIG. 6A) and the construction of a tetra-stranded nucleic acid nanocode (FIG. 6B). FIG. 7A illustrates the construction of a branched nanocode, wherein the ligatable ends are variously used to extend the length of the barcode and/or the branches. FIG. 7B illustrates the construction of branched nanocode, wherein the ligatable ends are variously used to extend the length of the barcode and/or attach a modifying object.

The present invention provides methods of using nanocodes for identifying a molecular probe. In one embodiment, a method is provided to identify a molecular probe, which is operably linked to a nanocode having a surface property, by contacting the molecular probe with an SPM probe, and detecting the surface property of the nanocode. The surface property provides a code that is detectable by SPM and is unique to a specified nanocode, wherein the code is defined by subfeatures, including, for example, by the relative thickness (diameter) of regions of the nanocode, by the relative size (e.g., height or length) of the nanocode or portions of the nanocode (e.g., branches or bubbles), by the presence (or absence) of one or more objects (tags, moieties), which can be the same or different objects, operably associated with the nanocode, by the length of the nanocode, or by any other surface property that can be detected using SPM (see Examples 1 to 4). By detecting the surface property of a nanocode operably linked to a molecular probe, and having knowledge of the particular nanocode, the molecular probe can be identified, as can a target molecule specifically bound by the molecular probe.

The present nanocodes, which are suitable for detection by SPM, are exemplified by mosaic nanocodes that include at least one nucleic acid component and at least one polypeptide component (see FIG. 6A), by nucleic acid nanocodes having regions of differing strandedness (e.g., regions of double strandedness and regions of tetra-strandedness; see FIG. 6B), by branched nucleic acid molecules (see FIG. 7A), and by nucleic acid nanocodes that contain at least one object that modifies the surface property of the nanocode operably linked thereto (see FIG. 7B). In view of the exemplified nanocodes, it will be recognized that the relative lengths of the nanocodes and the relative positions and/or sizes (e.g., lengths) of the subfeatures (e.g., branches) can be varied to produce nanocodes having a variety of different surface properties, and, further, that the exemplified nanocodes can provide a source of “base” nanocodes, which can be combined with (operably linked to) one or more of the same or different base nanocodes (e.g., by linking two nucleic acid nanocodes having regions of different strandedness to obtain a new nanocode having twice the length of the base nanocode; or by linking a nucleic acid nanocode having regions of different strandedness and a nucleic acid nanocode containing a modifying object) to generate diverse unique nanocodes. Upon operably linking such nanocodes to molecular probes such as antibodies (or antigens), receptors (or ligands), or oligonucleotides, the molecular probe and, if desired, a target molecule bound thereto, can be identified by using SPM to detect the code (surface property) of the 2nanocode.

A nanocode that is a mosaic biomolecule containing one or more nucleic acid regions and one or more peptide regions can have a surface property defined by the relative diameters of the nucleic acid and peptide regions, as well as by the relative lengths of each such region. Since a double stranded nucleic acid sequence has a smaller diameter than a double stranded peptide region (see FIG. 6A), SPM of a nanocode containing interspersed nucleic acid and peptide regions can reveal a pattern of diameters for a particular nanocode, thus allowing the identification of the nanocode (and a molecule bound thereto, including, for example, a molecular probe operably linked to the nanocode, or a target molecule specifically bound by such a molecular probe). The pattern of diameters detected by SPM of such a nanocode is defined by the relative lengths of each peptide and nucleic acid regions, which can be as short as a single amino acid or nucleotide in the corresponding region in each strand, or can be at least two (e.g., 2, 3, 4, 5, 6, 7, 8, 9, 10, or more) amino acid residues or nucleotides, and can be as long as desired (e.g., 50, 100, 200, 500 amino acid residues or nucleotides, or more), provided the nanocode surface property can be detected by SPM. For example, a mosaic nanocode comprising nucleic acid and peptide can contain independently one or more subfeatures of 5 to 100 amino acids (e.g., 5 to 50 amino acids) and one or more subfeatures of 5 to 100 nucleotides (e.g., 10 to 50 nucleotides).

A nanocode generally contains at least two (e.g., 2, 3, 4, 5) organic polymer strands (e.g., a double stranded nucleic acid nanocode), although the nanocodes can further contain single stranded regions (e.g., at a terminus of the full length structure or a terminus of a branch; see, e.g., FIG. 2B). In one embodiment, a nanocode further contains one or more regions of varying strandedness, including regions of greater than two strands (e.g., triple stranded, or tetra-stranded), such regions providing “bubbles” in an otherwise double stranded nanocode that can be detected by SPM as a region having a greater diameter than a double stranded region (see, e.g., FIG. 6B). A nanocode also can be a branched nanocode, which contains one or more branches that can be of varying lengths, thus providing unique surface properties (subfeatures; see, e.g., FIG. 7A). As disclosed herein, branches of a basic structure nanocode can be extended (e.g., using hybridizing oligonucleotides; see, e.g., FIG. 5), thus providing nanocodes having branches of various lengths. Combinations of the exemplified basic nanocode units also are provided, including, for example, nanocodes having one or more bubbles and one or more branches, nanocodes having one or more mosaic regions and one or more bubbles (and/or branches), etc.

Nanocodes also can be modified to contain one or more objects that affect the surface property of the nanocode such that the presence or absence or relative abundance of the modifying object can be identified by SPM. Such modifying objects, which can provide an additional level of diversity to the nanocodes, include nanoparticles such as silica, alumina, metal ions (e.g., gold or silver), or metal ion complexes (e.g., ferritin), which can be linked to one or more positions of a nanocode, including, for example, to one or more branches (see, e.g., FIG. 4; see, also, FIG. 7B). Methods of linking a modifying object to a nanocode are exemplified herein (see Example 1) or otherwise known in the art, and will depend, for example, on the chemical nature of the modifying object and the portion of the nanocode to which the object is to be linked (e.g., a nucleic acid component or a peptide component of a mosaic nanocode).

A nanocode can be operably linked to a molecular probe, thus allowing detection and identification of the molecular probe by SPM. The term “molecular probe” is used herein to refer to any molecule that exhibits selective and/or specific binding to one or more targets. In one embodiment, a molecular probe is operably linked to a nanocode, which is distinguishable based on its surface property as detected by SPM, and each molecular probe of a plurality of molecular probes is operably linked to one or more nanocodes, wherein individual molecular probes of the plurality are distinguishable based on the nanocode operably linked thereto. As such, binding of a particular molecular probe among a population of different molecular probes (e.g., to a target molecule) can be detected by determining a surface property of the operably linked nanocode using an SPM method.

As disclosed herein, any molecular probe, including, for example, a nucleic acid (e.g., an oligonucleotide probe or PCR primer), a peptide ( e.g., an antibody or antigen binding fragment of an antibody, a binding protein, or a receptor), a lectin, or other molecule that can act, for example, as a substrate, inhibitor, activator, or analyte (e.g., a hormone, a cytokine, a growth factor, etc.), can be operably linked to a nanocode, thus rendering the molecular probe identifiable by SPM. The term “analyte” refers to any atom, chemical, molecule, compound, composition or aggregate of interest for detection and/or identification. Non-limiting examples of analytes include an amino acid, peptide, polypeptide, protein, glycoprotein, lipoprotein, nucleoside, nucleotide, oligonucleotide, nucleic acid, sugar, carbohydrate, oligosaccharide, polysaccharide, fatty acid, lipid, hormone, metabolite, cytokine, chemokine, receptor, neurotransmitter, antigen, allergen, antibody, substrate, metabolite, cofactor, inhibitor, drug, pharmaceutical, nutrient, prion, toxin, poison, explosive, pesticide, chemical warfare agent, biohazardous agent, radioisotope, vitamin, heterocyclic aromatic compound, carcinogen, mutagen, narcotic, amphetamine, barbiturate, hallucinogen, waste product and/or contaminant.

As used herein, the term “operably coupled” or “operably linked” or “operably associated” means that there is an interaction between two or more units of a molecule, a complex, an apparatus and/or a system, wherein each component retains a function characteristic of the individual component. For example, an SPM probe can be operably coupled to a computer if the computer can obtain, process, store and/or transmit data on SPM signals detected by the detector. In another example, a surface property modifying object (e.g., a gold particle) can be operably associated with a nanocode, wherein the object is bound such that it remains associated with the nanocode under conditions to which the complex (nanocode-gold particle) is to be exposed (e.g., physiological conditions). In still another example, a molecular probe can be operably associated with nanocode having a surface property, wherein the molecular probe can specifically interact with a target molecule and the surface property of the nanocode can be identified. A molecular probe that is operably linked to a nanocode can be any type of molecule that specifically interacts with a target molecule, including, for example, a peptide (e.g., an antibody or a peptide comprising an epitope that is specifically bound by an antibody, an enzyme or a substrate acted upon by an enzyme), or a nucleic acid (e.g,. an oligonucleotide probe that specifically hybridizes to a target nucleic acid molecule, or a nucleic acid comprising a protein binding site such as a transcriptional regulatory element that is specifically bound by a transcription factor (or the protein component, e.g., a DNA binding domain of a transcription factor can be operably linked to the nanocode, thus allowing for detection by SPM of a nucleic acid regulatory element specifically bound by the transcription factor).

The term “binds specifically” or “specific binding activity” or “specifically interacts” or the like, when used in reference to a specific binding pair (e.g., a molecular probe and a target molecule), means that the molecular probe can associate with the target molecule with sufficient specificity such that the probe can be used to detect the presence of the target molecule. In general, a molecular probe that specifically binds a target molecule does not substantially interact with a second (or other molecule), including a second molecule that is structurally and/or functionally similar to the target molecule. However, a molecular probe also can be designed to have a more relaxed, but specific, binding activity (e.g., such that the molecular probe can identify related members of a family of target proteins or target nucleic acids (e.g., genes)), such relaxed but specific binding being encompassed within embodiments of the invention.

Specific binding can be identified using methods as disclosed herein or otherwise known in the art, and will depend, for example, on the phyico-chemical properties of the molecular probe and target molecule, including, for example, on whether the interacting molecules are nucleic acid, peptides (proteins), glycoproteins, etc. Similarly, conditions suitable for obtaining specific binding of a members of a specific binding pair are known in the art and will depend, for example, on the chemical nature of the interacting molecules, and whether the specific binding pair members are contacted in vitro (e.g., using purified or substantially purified components), or in a cell, which can be a cell in culture, a cell ex vivo, or a cell in situ (e.g., in vivo).

It is recognized that members of a specific binding pair can crossreact with related or unrelated molecules due, for example, to similar primary, secondary and/or tertiary structures present in such related or unrelated molecules as compared to a specific binding pair member. However, such crossreacting (non-specific) binding (e.g., cross-hybridization of nucleic acid probes, or cross-reactivity of antibodies), when not desired, can be identified using appropriate controls, and can be minimized or avoided by selecting conditions particularly favorable for the specific interaction (e.g., highly stringent nucleic acid hybridization conditions). For example, blocking agents (e.g., bovine serum albumin, Denhardt's reagent) can be included in an incubation medium such that non-specific binding of one or more reagents (e.g., molecular probe linked to nanocode) to a surface contacted by the reagents.

Specific binding of proteins (e.g., an antibody and its cognate epitope; or first and second interacting proteins in a biological pathway; or an enzyme and its substrate) can be identified, for example, by determining that the proteins have a dissociation constant of at least about 1×10⁻⁶ M, generally at least about 1×10⁻⁷ M, usually at least about 1×10⁻⁸ M, and particularly at least about 1×10⁻⁹ M or 1×10⁻¹⁰ M or less. For antibodies, specific binding also can be detected more qualitatively, for example, by detecting that an antiserum or other preparation containing the antibody has a relatively high titer for binding a specific protein (target molecule).

The term “antibody” is used herein in its broadest sense to include polyclonal and monoclonal antibodies, as well as antigen binding fragments of such antibodies. As such, whole antibodies and functional fragments thereof are contemplated, including intact antibody molecules as well as fragments thereof such as Fab and F(ab′)₂, Fv and SCA fragments that can specifically bind an epitopic determinant. An Fab fragment consists of a monovalent antigen-binding fragment of an antibody molecule, and can be produced by digestion of a whole antibody molecule with the enzyme papain, to yield a fragment consisting of an intact light chain and a portion of a heavy chain. An Fab′ fragment of an antibody molecule can be obtained by treating a whole antibody molecule with pepsin, followed by reduction, to yield a molecule consisting of an intact light chain and a portion of a heavy chain. Two Fab′ fragments are obtained per antibody molecule treated in this manner. An (Fab′)₂ fragment of an antibody can be obtained by treating a whole antibody molecule with the enzyme pepsin, without subsequent reduction. A (Fab′)₂ fragment is a dimer of two Fab′ fragments, held together by two disulfide bonds. An Fv fragment is defined as a genetically engineered fragment containing the variable region of a light chain and the variable region of a heavy chain expressed as two chains. A single chain antibody (“SCA”) is a genetically engineered single chain molecule containing the variable region of a light chain and the variable region of a heavy chain, linked by a suitable, flexible polypeptide linker.

The term “antibody” as used herein includes naturally occurring antibodies as well as non-naturally occurring antibodies, including, for example, single chain antibodies, chimeric, bifunctional and humanized antibodies, as well as antigen-binding fragments thereof. Such non-naturally occurring antibodies can be constructed using solid phase peptide synthesis, can be produced recombinantly or can be obtained, for example, by screening combinatorial libraries consisting of variable heavy chains and variable light chains (see Huse et al., Science 246:1275-1281, 1989). These and other methods of making, for example, chimeric, humanized, CDR-grafted, single chain, and bifunctional antibodies are well known to those skilled in the art (Winter and Harris, Immunol. Today 14:243-246, 1993; Ward et al., Nature 341:544-546, 1989; Harlow and Lane, “Antibodies: A laboratory manual” (Cold Spring Harbor Laboratory Press, 1988); Hilyard et al., “Protein Engineering: A practical approach” (IRL Press 1992); Borrabeck, “Antibody Engineering” 2d ed. (Oxford University Press 1995)). Modified or derivatized antibodies such as pegylated (polyethylene glycol modified) antibodies provide an additional example of antibodies.

Methods for raising polyclonal antibodies, for example, in a rabbit, goat, mouse or other mammal, are well known in the art (see, for example, Green et al., “Production of Polyclonal Antisera,” in Immunochemical Protocols (Manson, ed., Humana Press 1992), pages 1-5; Coligan et al., “Production of Polyclonal Antisera in Rabbits, Rats, Mice and Hamsters,” in Curr. Protocols Immunol. (1992), section 2.4.1). In addition, monoclonal antibodies can be obtained using methods that are well known and routine in the art (Harlow and Lane, supra, 1988).

Specific binding of an antibody molecular probe to a target molecule can be detecting using immunoassays, including competitive and non-competitive immunoassays in a direct or indirect format, as are known in the art. Such immunoassays include, for example, enzyme linked immunosorbent assays (ELISA), radioimmunoassays, and the like. In particular, where a molecular probe is operably linked to a nanocode, specific binding of the molecular probe to a target molecule can be detected using a scanning probe microscopy (SPM) method, wherein SPM is used to detect the surface property of the nanocode linked to the molecular probe.

A receptor (e.g., a cell surface receptor such as a T cell receptor, or an intracellular receptor such as a G-protein coupled receptor) provides another example of a molecular probe, which can be operably linked to a nanocode, or a target molecule. Receptors are well known in the art, and include receptors that are made up of a single protein (polypeptide), and receptor complexes, which can include two or more of the same or different protein subunits (e.g., homodimers, heterotrimers, and the like). A receptor generally is characterized in that it specifically binds a particular molecule (i.e., a ligand), which can be a protein, nucleic acid, or small organic molecule, or other molecule. Generally, binding of a ligand to a receptor triggers a specific response, for example, a cellular response.

As such, it will be recognized that a nanocode suitable for detection by SPM can be operably linked to any polypeptide, particularly a polypeptide that specifically interacts with a second (or more) molecule (e.g., a second polypeptide such as an enzyme, or a nucleic acid molecule such as a gene regulatory element). The term “polypeptide” or “peptide” is used broadly herein to mean two or more amino acids linked by a peptide bond. As such, the term “polypeptide” or “peptide” is not used herein to suggest a particular size or number of amino acids comprising the molecule, and, therefore, can contain 2, 3, 4, 5, 6, 7, 8, 9, 10, or more (e.g., 20, 40, 60, 80, 100) amino acid residues or more. A protein is a polypeptide that is produced in a cell and can be modified, for example, by a post-translational modification to include chemical moieties other than amino acids, including, for example, one or more phosphate groups (phosphoprotein), carbohydrate moieties (glycoproteins), or nucleic acid molecules (nucleoprotein).

A nucleic acid molecular probe operably linked to a nanocode also can be detected by SPM according to embodiments of the present invention. Specific binding of nucleic acids (e.g., an oligonucleotide probe to a target nucleotide sequence) can be identified by detecting binding under stringent hybridization and/or washing conditions. An oligonucleotide molecular probe is of a sufficient length, generally at least about 15 bases in length (e.g., 15, 16, 17, 18, 19, 20, 21, 25, 30, 40, 50, or more) such that the oligonucleotide selectively hybridizes to a target molecule. As used herein, the term “selective hybridization” or “selectively hybridize” refers to hybridization under moderately stringent or highly stringent physiological conditions, which can distinguish related nucleotide sequences from unrelated nucleotide sequences.

In nucleic acid hybridization reactions, the conditions used to achieve a particular level of stringency will vary, depending on the nature of the nucleic acids (i.e., molecular probe and target nucleic acid molecule) being hybridized. For example, the length, degree of complementarity, nucleotide sequence composition (for example, relative GC:AT content), and nucleic acid type, i.e., whether the oligonucleotide or the target nucleic acid molecule is DNA or RNA, can be considered in selecting hybridization conditions (see, e.g., Sambrook et al., “Molecular Cloning: A laboratory manual” (Cold Spring Harbor Laboratory Press, Cold Spring Harbor N.Y. 1989). An additional consideration is whether one of the nucleic acids is immobilized, for example, on a filter. Methods for selecting appropriate stringency conditions can be determined empirically or estimated using various formulas, and are well known in the art (see, for example, Sambrook et al., supra, 1989). An example of progressively higher stringency conditions is as follows: 2×SSC/0.1% SDS at about room temperature (hybridization conditions); 0.2×SSC/0.1% SDS at about room temperature (low stringency conditions); 0.2×SSC/0.1% SDS at about 42° C. (moderate stringency conditions); and 0.1×SSC at about 68° C. (high stringency conditions). Washing can be carried out using only one of these conditions, for example, high stringency conditions, or each of the conditions can be used, for example, for 10 to 15 minutes each, in the order listed above, repeating any or all of the steps listed. Hybridization conditions that include formamide (e.g., 50% formamide), wherein hybridization is performed at a lower temperature (e.g., 40-50° C.), also can be used as is known in the art.

The term “nucleic acid” or “polynucleotide” is used broadly herein to mean a sequence of two or more deoxyribonucleotides or ribonucleotides that are linked together by a covalent bond. As such, the term “nucleic acid” or “polynucleotide” includes RNA and DNA, which can be a gene or a portion thereof, a cDNA, a synthetic polydeoxyribonucleic acid sequence, or the like, and can be single stranded, double stranded, triple stranded, tetra-stranded, or more, as well as DNA/RNA hybrids. A nucleic acid can be a naturally occurring polynucleotide, which can be isolated from a cell, or a synthetic molecule, which can be prepared, for example, by methods of chemical synthesis or by enzymatic methods such as by the polymerase chain reaction (PCR).

It should be recognized that a nucleic acid can be a target molecule, a molecular probe (which can be operably linked to a nanocode), and/or a component of a nanocode. As such, the nucleic acid can contain nucleoside or nucleotide analogs, or a backbone bond other than a phosphodiester bond. Thus, the nucleotides comprising a nucleic acid can include naturally occurring deoxyribonucleotides, such as adenine, cytosine, guanine or thymine linked to 2′-deoxyribose, or ribonucleotides such as adenine, cytosine, guanine or uracil linked to ribose, and/or can contain nucleotide analogs, including non-naturally occurring synthetic nucleotides or modified naturally occurring nucleotides. Such nucleotide analogs are well known in the art and commercially available, as are polynucleotides containing such nucleotide analogs (Lin et al., Nucl. Acids Res. 22:5220-5234, 1994; Jellinek et al., Biochemistry 34:11363-11372, 1995; Pagratis et al., Nature Biotechnol. 15:68-73, 1997).

The covalent bond linking the nucleotides of a polynucleotide can be a phosphodiester bond, or can be any of numerous other bonds, including a thiodiester bond, a phosphorothioate bond, a peptide-like bond or any other bond known to those in the art as useful for linking nucleotides to produce synthetic polynucleotides (see, for example, Tam et al., Nucl. Acids Res. 22:977-986, 1994; Ecker and Crooke, BioTechnology 13:351360, 1995). The incorporation of non-naturally occurring nucleotide analogs or bonds linking the nucleotides or analogs can be particularly useful where the nucleic acid (e.g., molecular probe and/or nanocode) is to be exposed to an environment that can contain a nucleolytic activity, including, for example, a tissue culture medium or an in vivo environment, since the modified polynucleotides can be less susceptible to degradation.

A nucleic acid containing naturally occurring nucleotides and phosphodiester bonds can be chemically synthesized or can be produced using recombinant DNA methods, using an appropriate polynucleotide as a template. In comparison, a nucleic acid comprising nucleotide analogs or covalent bonds other than phosphodiester bonds generally are chemically synthesized, although an enzyme such as T7 polymerase can incorporate certain types of nucleotide analogs into a polynucleotide and, therefore, can be used to produce such a polynucleotide recombinantly from an appropriate template (Jellinek et al., supra, 1995).

Depending on whether the nucleic acid comprises a target molecule, a molecular probe, a nanocode, or a component thereof, it can be of any length of interest, including about 5, 6, 7, 8, 9, 10, 20, 30, 40, 50, 60, 75, 100, 125, 150, 175, 200, 225, 250, 275, 300, 400, 500, 600, 700, 800, 900, 1000, 1500, 2000, 2500, 3000, 3500, 4000, 4500, 5000, 6000, 7000, 8000, 9000, 10,000, 15,000, 20,000, 30,000, 40,000, 50,000, 75,000, 100,000, 150,000, 200,000, 500,000, 1,000,000, 1,500,000, 2,000,000, 5,000,000, or more bases or base pairs in length, up to a full length chromosomal DNA molecule. For example, a nucleic acid molecular probe comprising a transcription factor binding site (e.g., a gene regulatory element such as a promoter or enhancer) can be from about 5 to 1000 nucleotides (e.g., about 8 to 100, or 10 to 50), whereas a molecular probe comprising a hybridizing oligonucleotide can be from about 15 to 1000 (or more) nucleotides (e.g., about 15, 16, 17, 18, 19, 20, 25, 30, 40, or more nucleotides). A nucleic acid component of a nanocode can vary, for example, from about 5 to 500 nucleotides (e.g., 10 to 100). In comparison, a target nucleic acid molecule can be from a few nucleotides in length (e.g., where the target is a gene regulatory element) to a full length chromosome (e.g., where an in situ hybridization procedure using a molecular probe operably linked to a nanocode is being used to identify a gene locus (or the absence thereof) on a chromosome). As such, the nucleic acids can be referred to, without limitation, as oligonucleotides and/or polynucleotides.

A specific binding pair can include two different types of molecules, e.g., a nucleic acid molecule and a polypeptide, either of which can be operably linked to a nanocode and serve as a molecular probe. For example, transcription factors are proteins that include a DNA binding domain, which specifically binds a target nucleic acid sequence (a transcriptional regulatory element), and a transcriptional activation (trans-activation) domain, which specifically binds other transcription factors and/or accessory proteins (e.g., eukaryotic initiation factors). As such, transcription factors, or a domain thereof, e.g., a DNA binding domain, can be operably linked to a nanocode and used as a molecular probe for SPM to identify gene regulatory element(s) specifically bound by the transcription factor. Alternatively, oligonucleotides that are designed to have a characteristic of a transcriptional regulatory element, or that are based on an upstream nucleotide sequence of a gene (i.e., 5′ to the coding sequence), can be operably linked to a nanocode and used as a molecular probe for SPM to identify a transcription factor that specifically binds to and regulates the expression of a particular gene. Methods for detecting specific binding of a protein and a nucleic acid are well known in the art and include, for example, gel electrophoresis mobility shift assays and affinity chromatography assays.

Accordingly, methods are provided for detecting a target molecule by contacting a sample, which contains or is suspected of containing (or which is known not to contain and is being used as a control)) the target molecule with a molecular probe, which is operably linked to a nanocode having a surface property, under conditions suitable for specific binding of the molecular probe to the target molecule; and detecting binding of the nanocode to the target molecule, when present, by SPM. According to the present methods, SPM is used to identify a molecular probe specifically bound to a target molecule, wherein a change in a signal due to a nanocode operably linked to the molecular probe in the presence of the target molecule as compared with the signal in the absence of the target molecule is indicative of specific binding of the molecular probe to the target molecule. As such, the present methods can be used to identify the presence (or absence) of a target molecule (e.g., in a sample such as a biological sample), and can further be used to determine the relative amount of a target molecule in a sample. Quantification of a target molecule can be performed, for example, by measuring the signal intensity of bound nanocode and comparing the signal to a calibration curve prepared using known amounts of a nanocode standardized preparation. By identifying the surface property of the nanocode using SPM, and knowing the specific molecular probe to which a nanocode having the particular surface property is operably associated, the identity of the molecular probe, as well as the identity of the target molecule to which the molecular probe is specifically bound, can be determined.

A target molecule can be any molecule that can be specifically bound by a molecular probe, including, for example, a biomolecule (e.g., a molecule that is produced in a living organism as part of a normal or abnormal biological process) or an environmental molecule (e.g., a pollutant or contaminant such as an industrial product,), which also can be a biomolecule. As such, the target molecule can be a protein, a peptide, a glycoprotein, a lipoprotein, a prion, a nucleic acid, a polynucleotide, an oligonucleotide, a lipid, a fatty acid, a carbohydrate, a glycolipid, a phospholipid, a sphingolipid, a lipopolysaccharide, a polysaccharide, a eukaryotic cell, a prokaryotic cell, a bacterium, a phage, a virus, a pathogen, or any organic or non-organic molecule for which a molecular probe (i.e., specific binding partner) is available (e.g., dioxin, which can be specifically bound by an aromatic hydrocarbon (dioxin) receptor (AhR) molecular probe).

In one embodiment, the method allows for the identification of a target molecule in a biological sample. The term “biological sample” is used herein to refer to any specimen comprising and/or obtained from a living organism. In certain embodiments, a biological sample can be a sample obtained from a subject of interest (e.g., a human patient suffering from an unknown disorder, or a patient believed to be suffering from a particular disorder), including, for example, a urine, blood, plasma, serum, saliva, semen, stool, sputum, cerebral spinal fluid, tears, mucus, cell, tissue, or organ sample. In further embodiments, the biological sample is a sample obtained from a mammalian subject, including, for example, a feline, canine, ovine, bovine, porcine, murine, or human subject.

A biological sample generally, though not necessarily, comprises a sample that contains or is suspected of containing a target molecule (i.e., a second specific binding pair member), and that allows for, or can be modified (e.g., diluted, concentrated, or fractionated) to allow for, detection by SPM of a nanocode operably linked to a molecular probe. The biological sample can be a cell, tissue or organ sample (e.g., a biopsy sample) comprising at least one (e.g., 1 to 10,000,000; 1000 to 10,000,000; or 1,000,000 to 10,000,000) somatic cell and/or germ cell, and can contain one or more biologic fluids that may normally be associated with the cell, tissue or organ (e.g., blood, lymph, or interstitial fluid). The biological sample also can be a cell, tissue or organ extract (or an aliquot or fraction thereof), which can, but need not, contain intact cells. As mentioned above, the biological sample also can be a biological fluid (e.g., urine, saliva, sputum, blood serum, cerebrospinal fluid, or semen.). Where the sample is a biological sample obtained from a mammalian subject (e.g., a human), it can be obtained by any method typically used to obtain the particular type of sample, including, for example, by surgery, biopsy, swab, stool, or other collection method. The sample also can be a forensic sample obtained, for example, at a crime scene or in association (or suspected association) with a crime, including, for example, a biological sample obtained from a weapon (e.g., a knife), clothes, or a wall or floor. In other embodiments, the biological sample contains, or is suspected of containing, a pathogen, for example a viral, fungal, or bacterial pathogen, or is obtained from a subject at risk of containing the pathogen (e.g., to monitor the susceptible subject for the presence of the pathogen). The biological sample also can be sample of a plant.

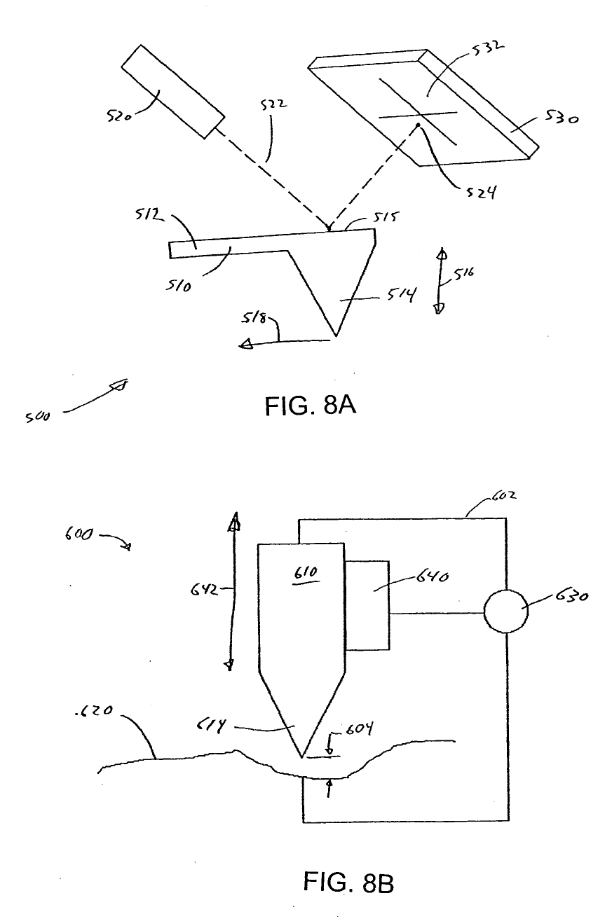

The nanocodes useful for preparing compositions and practicing embodiments of the present methods provide surface properties that are particularly suitable for detection by SPM. As such, SPM is used to detect nanocodes, particularly the surface properties (subfeatures) of nanocodes, that are operably linked to a molecular probe. SPM utilizes a variety of instruments that can measure the physical properties of objects on a nanometer-to-micrometer scale. Different modalities of SPM technology are available, any of which can be used for detection and/or identification of a nanocode according to embodiments of the invention. In general, an SPM instrument uses a laser beam or a very small, pointed probe in very close proximity to a surface to measure the properties of objects (see FIGS. 8A and 8B). In some types of SPM instruments, the SPM probe is mounted on a cantilever that can be a few hundred microns in length and between about 0.5 and 5.0 microns (micrometers) thick. Typically, the SPM probe tip is raster-scanned across a surface in an “xy” pattern to map localized variations in surface properties. SPM methods of use for imaging biomolecules and/or detecting molecules of use as nanocodes are well known in the art (e.g., Wang et al., Amer. Chem. Soc. Lett., 12:1697-98. 1996; Kim et al., Appl. Surface Sci. 130, 230, 340-132:602-609, 1998; Kobayashi et al., Appl. Surface Sci. 157:228-32, 2000; Hirahara et al., Phys. Rev. Lett. 85:5384-87 2000; Klein et al., Applied Phys. Lett. 78:2396-98,2001; Huang et al, Science 291:630-33,2001; Ando et al., Proc. Natl. Acad. Sci., USA 12468-72, 2001).

Scanning tunneling microscopy (STM) is an SPM technique that relies on the existence of quantum mechanical electron tunneling between the STM probe tip and the sample surface. The tip is sharpened to a single atom point and is raster scanned across the surface, maintaining a probe-surface gap distance of a few angstroms without actually contacting the surface. A small electrical voltage difference (on the order of millivolts to a few volts) is applied between the probe tip and sample and the tunneling current between tip and sample is determined. As the tip scans across the surfaces, differences in the electrical and topographic properties of the sample cause variations in the amount of tunneling current. The relative height of the tip can be controlled by piezoelectric elements with feed-back control, interfaced with a computer. The computer can monitor the current intensity in real time and move the tip up or down to maintain a relatively constant current. In different embodiments, the height of the tip and/or current intensity may be processed by the computer to develop an image of the scanned surface.

Because STM measures the electrical properties of the sample as well as the sample topography, it can distinguish between different types of conductive material such as different types of metal (e.g., metal modifying agents linked to a nanocode). STM also can measure local electron density. Because the tunneling conductance is proportional to the local density of states (DOS), STM can be used to distinguish surface properties that vary in their electronic properties depending on the diameter and/or length of a subfeature. As such, STM can be used to detect and/or identify, as well as distinguish, any nanocodes that differ in their electrical properties. Where the nanocode is operably linked to a molecular probe, the identification of a particular nanocode consequently identifies the molecular probe and, where present, a target molecule specifically bound by the molecular probe.

FIG. 8B illustrates selected functional components of a STM (U.S. Pat. Appl. Publ. No. US2003/0148289 A1). A probe 610, including a tip portion 614, is electrically coupled to a substrate 620 along circuit 602. An electrical characteristic such as an electrical potential is measured between the tip portion 614 and the substrate 620. The electrical characteristic is measured by a detector 630 that provides feedback to a linear actuator 640 such as a piezoelectric device. In one embodiment, a distance 604 between the tip portion 614 and the substrate 620 is monitored and adjusted by a feedback loop. In another embodiment, the actuator 640 is controlled by the detector 630 such that the tip maintains a constant distance 604 over the substrate and the movements of the tip portion record surface characteristics along a given scan line. In another embodiment, a constant height of the tip portion 614 is maintained and variation in an electrical characteristic such as potential are recorded to provide surface characteristics along a given scan line. As such, STM can be used to identify surface properties of a nanocode and, therefore, identification of a particular nanocode.

Another modality of SPM is atomic force microscopy (AFM). Methods of biomolecule analysis by AFM are well known (see, e.g., Uchihashi et al., “Application of Noncontact-Mode Atomic Force Microscopy to Molecular Imaging”, on the world wide web, at URL “http://www.foresight.org/Conferences/MNT7/Abstracts/Uchihashi”). In AFM microscopy, the probe is attached to a spring-loaded or flexible cantilever that is in contact with the surface to be analyzed. Contact is made within the molecular force range (i.e., within the range of interaction of van der Waals forces).

Within AFM, different modes of operation are possible, including contact mode, non-contact mode and TappingMode™ mode. In contact mode, the atomic force between probe tip and sample surface is measured by keeping the tip-to-sample distance constant and measuring the deflection of the cantilever, typically by reflecting a laser off the cantilever onto a position sensitive detector. Cantilever deflection results in a change in position of the reflected laser beam. As in STM, the height of the probe tip in AFM can be computer controlled using piezoelectric elements with feedback control. In an embodiment of the invention, a relatively constant degree of deflection is maintained by raising or lowering the probe tip. Because the probe tip may be in actual (van der Waals) contact with the sample, contact mode AFM tends to deform non-rigid samples. In non-contact mode, the tip is maintained between about 50 to 150 angstrom above the sample surface and the tip is oscillated. Van der Waals interactions between the tip and sample surface are reflected in changes in the phase, amplitude or frequency of tip oscillation. The resolution achieved in non-contact mode is relatively low.

In TappingMode™ mode, the cantilever is oscillated at or near its resonant frequency using piezoelectric elements. The AFM tip periodically contacts (taps) the sample surface, at a frequency of about 50,000 to 500,000 cycles per second in air and a lower frequency in liquids. As the tip begins to contact the sample surface, the amplitude of the oscillation decreases. Changes in amplitude are used to determine topographic properties of the sample. Because AFM analysis does not depend on electrical conductance, it can be used to analyze the topological properties of non-conductive materials. The nanocodes disclosed herein, including, for example, mosaic nanocodes and/or nanocodes containing bubbles and/or branches, and that can, but need not contain modifying objects, differ in their topological properties and, therefore, can be detected and/or identified using AFM techniques.

FIG. 8A illustrates selected functional components of an atomic force microscope 500 (U.S. Pat. Appl. Publ. No. US2003/0148289). A cantilever 510 is shown with an arm portion 512 and a tip portion 514. An optical source 520 such as a laser emits a beam 522 toward a backside 515 of the tip portion 514. The beam reflects off the backside 515 and generates a spot 524 on a detector 530. The detector includes a photosensitive plane 532 that detects a two dimensional location of the spot 524 within the photosensitive plane 532. A force 518 acting on the tip portion 514 of the cantilever 510, such as a friction force, causes the tip portion to deflect upwards or downwards along direction 516. The deflection of the tip portion 514 in turn causes movement of the spot 524, which detects the surface characteristics present on the substrate.

In alternative modes of AFM, information in addition to the topological profile of the sample can be obtained. For example, in lateral force microscopy (LFM), the probe is scanned perpendicular to its length and the degree of torsion of the cantilever is determined. Cantilever torsion will be dependent on the frictional characteristics of the surface. Since the frictional characteristics of coded probes may vary depending on their composition, LFM can be useful to detect and identify different nanocodes.

Another variation of AFM is chemical force microscopy (CFM), in which the probe tip is functionalized with a chemical species and scanned over a sample to detect adhesion forces between the chemical species and the sample (Frisbie et al., Science 265:2071-2074, 1994). Chemicals with differing affinities for nanocode materials (e.g., gold or silver) can be incorporated into an AFM probe tip and scanned across a surface to detect and identify nanocodes. Another SPM mode of potential use is force modulation imaging (Maivald et al., Nanotechnology 2:103, 1991). Uchihashi et al. (supra) disclose a method of biomolecule imaging using frequency modulation in non-contact mode AFM.

Other SPM modes that can be used to detect and/or identify nanocodes as disclosed herein include magnetic force microscopy (MFM), high frequency MFM, magnetoresistive sensitivity mapping (MSM), electric force microscopy (EFM), scanning capacitance microscopy (SCM), scanning spreading resistance microscopy (SSRM), tunneling AFM, and conductive AFM. In certain of these modalities, magnetic properties of a sample can be determined, for example, of nanocodes modified to contain appropriate metal ions. SPM instruments of use for coded probe detection and/or identification are commercially available (e.g., Veeco Instruments, Inc., Plainview N.Y.; Digital Instruments, Oakland, Calif.). Alternatively, a custom designed SPM instrument can be used.

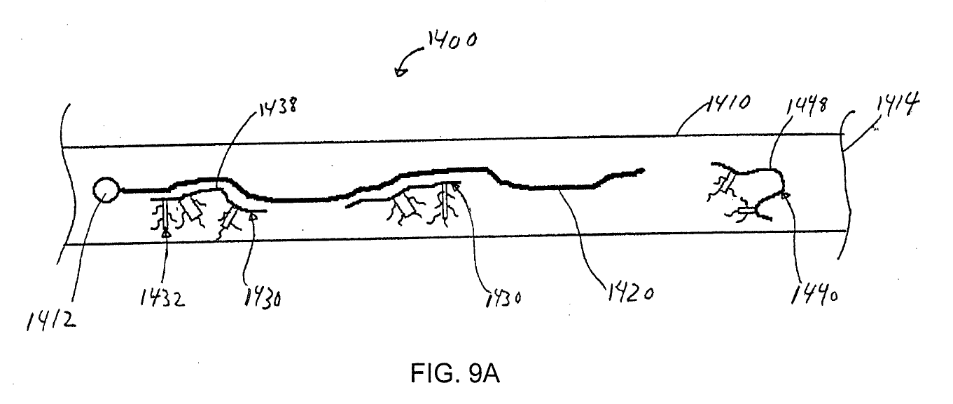

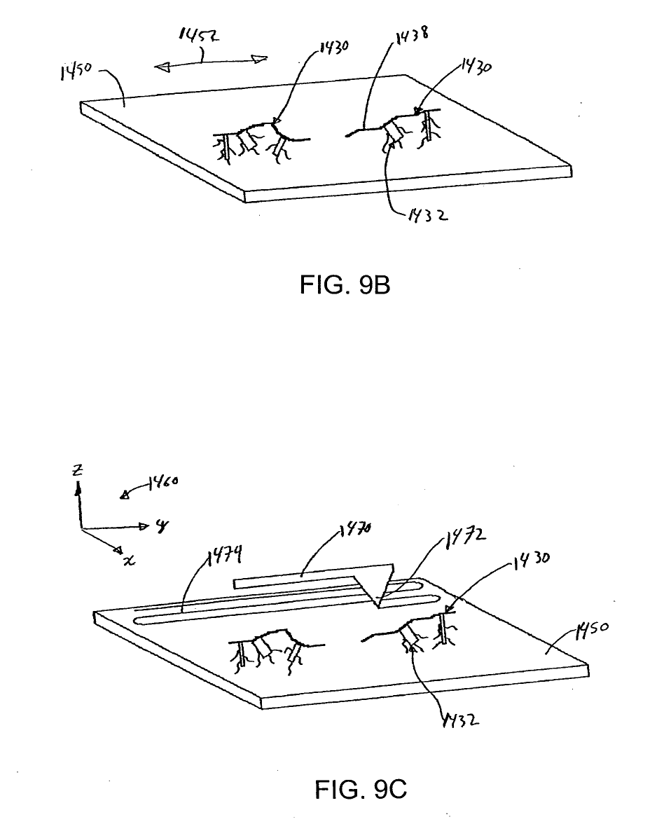

In another embodiment, a molecular characterization system is provided for biomolecule analysis. A molecular characterization system 1400 is illustrated in FIG. 9A (U.S. Pat. Appl. Publ. No. US2003/0148289). The characterization system 1400 includes a reaction chamber 1410 with an anchor point 1412. A sample molecule 1420 (e.g., a DNA molecule) is attached at the anchor point 1412 in preparation for characterization. A number of molecular probes operably linked to nanocodes (molecular probe/nanocode) 1430 are then introduced to the reaction chamber 1410 and the sample molecule 1420. Each molecular probe/nanocode 1430 includes a molecular probe 1438 and one or more nanocode structures 1432 attached along a length of the molecular probe 1438. Any number of variations of molecular probe/nanocodes 1430 can be introduced into the reaction chamber 1410.

In the characterization process, certain molecular probes 438 of molecular probe/nanocodes 430 specifically bind (e.g., selectively hybridize) with the sample molecule 420. If a known molecular probe 438 hybridizes at a specific location on the sample molecule 420, an inference can be made about characteristics of the sample molecule (e.g., that the sample molecule 420 comprises a target molecule that is specifically bound by the molecular probe 438). In the characterization process, other molecular probes 448 associated with other molecular probe/nanocodes 440 will not specifically bind the sample molecule 420 because the sample molecule 420 does not comprise a target molecule. Such molecular probe/nanocodes 440 can be removed (e.g., eluted) from the reaction chamber 410 at a chamber outlet 414.

Referring to FIG. 9B, after the sample molecule 1420 has been contacted with a sufficient (desired) number of different molecular probe/nanocodes 1440, the sample molecule 1420 is removed from the reaction chamber 1410 and placed on a substrate 1450. The substrate can be, for example, a wafer of silicon, mica, or highly ordered pyrolytic graphite (HOPG). In one embodiment, the molecular probe/nanocodes 1430 are oriented in an addressable pattern (e.g., an array). In another embodiment, the number of molecular probe/nanocodes 1430 that are specifically bound to the sample (target) molecule 1420 are removed from the sample molecule 1420 using a denaturing step, wherein the ordering of the nanocode structures 1432 along an axis such as 1452 is preserved, and surface properties of the nanocode structures are detected by SPM.

As illustrated in FIG. 9C, an SPM surface analysis device can be used to characterize the surface of the substrate 1450 and any particles that are on the surface of the substrate, particularly any nanocode structures 1432. In one embodiment, AFM is used as the surface analysis device (see FIG. 9C, showing a portion of an AFM cantilever 1470 with an associated tip 1472). During the surface analysis of the substrate 1450, the tip 1472 of the cantilever 1470 traces out a scan path 1474. As indicated by coordinate axes 1460, in one embodiment, the scan path includes an x-y scanning plane with scans in the y direction and translations in the x direction, though it will be recognized that scans in other directions (e.g., in the x direction) also can be performed.

A molecular characterization system can be operably linked, for example, to an information processing and control system, which can be used to analyze data obtained from an SPM instrument and/or to control the movement of the SPM probe tip, the modality of SPM imaging used and the precise technique by which SPM data is obtained. An exemplary information processing system may incorporate a computer comprising a bus for communicating information and a processor for processing information.

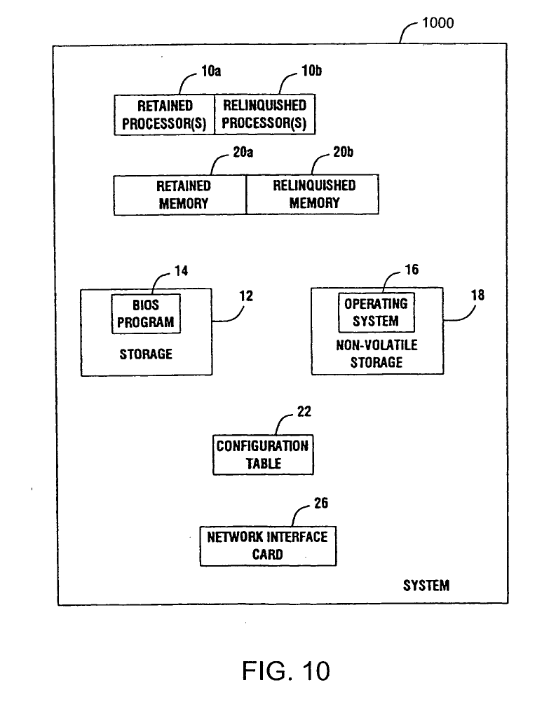

Referring to FIG. 10, information processing system 1000 includes processor 10, which includes processor 10a and, optionally, processor 10b, wherein two processors can provide a faster boot time (see, e.g., U.S. Pat. No. 6,766,474). Accordingly, in one embodiment, an information processing system includes one processor. In another embodiment, the information processing system includes at least two (e.g., 2, 3, 4) processors. System 1000 further includes memory 20, which, when two (or more) processors are present, can be divided into portions, including retained memory 20a and relinquished memory 20b. Memory 20 can include random access memory (RAM), dynamic random access memory (DRAM), synchronous DRAM (SDRAM) or Rambus® DRAM (RDRAM). In one embodiment, software for both power-on and run-time operation of the system 1000 are included. A BIOS program 14 executes as the system 1000 receives power, and performs initialization and testing of components within or connected to the system 1000 (e.g., video and audio devices, mass storage media, keyboard and mouse circuitry, serial and parallel ports, and/or memory). In one embodiment, the BIOS program 14 resides in a storage 12 such as a read-only memory (ROM). In a second embodiment, the storage 12 is a flash memory device. In other embodiments, a different power-on program that is not BIOS-based can be utilized in performing the operations.

For run-time operation, the system 100 further includes an operating system program 16. In one embodiment, the operating system program 16 resides in a non-volatile storage device 18, such as a hard disk drive or compact disk (CD) ROM. In a second embodiment, the operating system program 16 does not reside on the system 1000. Instead, the system 1000 is accessible to a network (not shown) by a network interface card 26. Once the network connection is made, the operating system software 16 can be downloaded to the system 1000. In one embodiment of system 1000 containing processor 10a and optional processor 10b, the BIOS program 14 retains control of a portion of the system 1000 instead of relinquishing full control of the system 1000 to the operating system 16. This enables the BIOS program 14 to minimally configure and test the system 1000 such that the operating system can be booted more expeditiously. Further, the portion of the system that was not relinquished to the operating system 16 can be fully initialized and tested during runtime, e.g., after the system 1000 is fully capable. Accordingly, as illustrated in FIG. 10, processor 10a is deemed a “retained” processor, e.g., that processor that is retained by the BIOS program 14; and processor 10b is known as a “relinquished” processor, as one relinquished to the operating system 16 by the BIOS program 14. Further, more than one processor 10a can be retained and more than one processor 10b can be relinquished. Like processors 10, memory 20 can be divided into retained memory portion 20a and relinquished memory portion 20b.

In one embodiment, the system 1000 further includes a configuration table 22, which is accessible to both the BIOS program 14 and the operating system program 16. Configuration table 22 includes information about resources within and connected to the system 1000. In particular, configuration table 22 supplies the operating system 16 with the amount of memory 20 available in the system 1000 as well as the number and type of processor(s) 10. In one embodiment, the processor(s) of a system is selected from the Pentium® family of processors, including without limitation the Pentium® II family, the Pentium® III family and the Pentium® 4 family of processors available from Intel Corp. (Santa Clara, Calif.). In alternative embodiments, the processor can be a Celeron® processor, an Itanium® processor, an X-Scale® processor, or a Pentium Xeon® processor (Intel Corp., Santa Clara, Calif.). In various other embodiments of the invention, the processor may be based on Intel® architecture, such as Intel® IA-32 or Intel® IA-64 architecture. Other processors also can be used.

As discussed above, the information processing system (computer) can further include a random access memory (RAM) or other dynamic storage device, a read only memory (ROM) or other static storage and a data storage device such as a magnetic disk or optical disc and its corresponding drive. The information processing system also can include other peripheral devices known in the art, including, for example, a display device (e.g., cathode ray tube or liquid crystal display), an alphanumeric input device (e.g., keyboard), a cursor control device (e.g., mouse, trackball, or cursor direction keys) and/or a communication device (e.g., modem, network interface card, or interface device used for coupling to an Ethernete link, token ring, or other type of network).

In particular embodiments of the invention, an SPM unit can be connected to the information processing system. Data from the SPM can be processed by the processor and data stored in the main memory. The processor can analyze the data from the SPM to identify a nanocode and, therefore, a molecular probe and/or target molecule associated therewith.

It is appreciated that a differently equipped information processing system can be used for certain implementations and, therefore, that the configuration of the system can vary. For example, while the processes disclosed herein can be performed under the control of a programmed processor, in alternative embodiments, the processes can be fully or partially implemented by any programmable or hardcoded logic, such as Field Programmable Gate Arrays (FPGAs), TTL logic, or Application Specific Integrated Circuits (ASICs), and the like. Additionally, the disclosed methods can be performed by any combination of programmed general purpose computer components and/or custom hardware components.

In certain embodiments of the invention, custom designed software packages can be used to analyze the data obtained from an SPM. In other embodiments, data analysis can be performed, for example, using an information processing system and publicly available software packages. Non-limiting examples of available software for DNA sequence analysis include the PRISM™ DNA Sequencing Analysis Software (Applied Biosystems; Foster City Calif.), the Sequencher™ package (Gene Codes; Ann Arbor Mich.), and a variety of software packages available through the National Biotechnology Information Facility on the worldwide web at the URL “nbif.org/links/1.4.1.php”.

Accordingly, in one embodiment, a molecular characterization system is provided, wherein the molecular characterization system includes a reaction chamber, which can contain at least one sample, and at least one molecular probe operably linked to a nanocode. In another embodiment, the reaction chamber comprises a substrate, which contains the sample or a plurality of samples, which can be the same or different or a combination thereof. In still another embodiment, the molecular characterization system comprises a plurality of molecular probes, wherein each molecular probe of the plurality is operably linked to a nanocode, wherein molecular probes of the plurality are the same or different, and wherein each of different molecular probes is operably linked to the same or different nanocodes. In one aspect, each of different molecular probes is operably linked to each of different nanocodes, wherein the nanocode identifies the molecular probe.

In another embodiment, an apparatus is provided, wherein the apparatus includes a substrate, which comprises a molecular probe operably linked to a nanocode; an SPM probe, which can detect a surface property of the nanocode, wherein the SPM probe is in operable association with the substrate; and a detector operably coupled to the SPM probe, wherein the detector provides a signal representative of a surface property of the nanocode. Such an apparatus can further include a processor, which can detect specific binding of the molecular probe comprising the nanocode to a target molecule. In various embodiments, the nanocode can be a mosaic biomolecule comprising a nucleic acid bound to a polypeptide; a nucleic acid molecule comprising regions of differing strandedness; a branched nucleic acid molecule; a nucleic acid molecule comprising an object that affects the surface property of the nanocode; or a combination thereof.

In still other embodiments, solutions containing one or more nanocodes as disclosed herein can be applied to property (e.g., personal property or commercial property) for security tracking purposes, as is known in the art. For example, SmartWater Ltd., a British company, has developed methods to mark valuables with fluids containing strands of digital DNA. The DNA is virtually impossible to wash off of the article and can be used to uniquely identify expensive items or heirlooms. The DNA can be detected by any forensic laboratory. Such methods can also be utilized to mark items with the molecular nanocodes disclosed herein. In such applications, detection of the nanocode would not require forensic analysis based on DNA sequence.

An apparatus for barcode preparation, use, and/or detection can be incorporated into a larger apparatus and/or system. In certain embodiments, the apparatus can include a micro-electro-mechanical system (MEMS). MEMS are integrated systems including mechanical elements, sensors, actuators, and electronics, all of which can, but need not, be manufactured by microfabrication techniques on a common chip, of a silicon-based or equivalent substrate (see, e.g., Voldman et al., Ann. Rev. Biomed. Eng. 1:401-425, 1999). The sensor components of MEMS can be used to measure mechanical, thermal, biological, chemical, optical and/or magnetic phenomena to detect barcodes. The electronics can process the information from the sensors and control actuator components such as pumps, valves, heaters, and the like, thereby controlling the function of the MEMS.

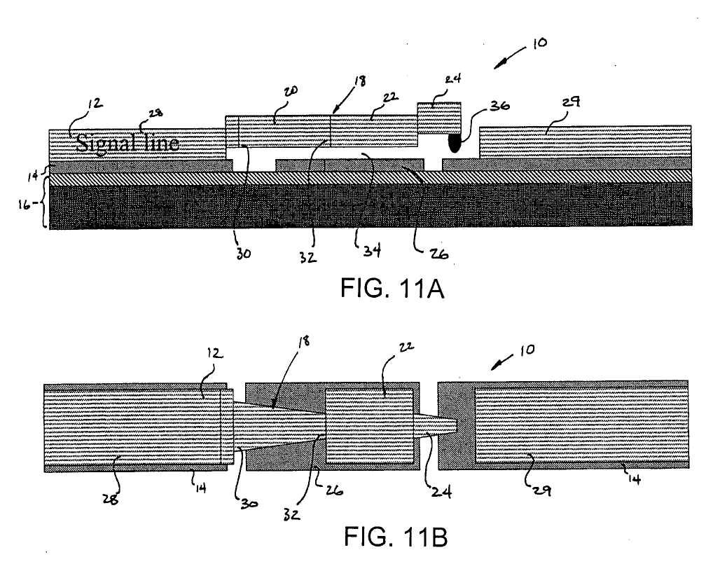

FIGS. 11A and 11B illustrate a MEMS cantilever series switch 10, which can be positioned between a SMP probe and a processor, or between a processor and a display, and can effect transmission of a signal from an SPM probe and indicate a nanocode subfeature. The MEMS switch 10 includes an anchor 12 mounted to a dielectric pad 14 attached to a substrate 16, and a cantilever beam 18 that includes a tapered portion 20, an actuation portion 22, and a tip 24 (see U.S. Pat. No. 6,686,820). An actuation electrode 26 is mounted to the substrate 16 and positioned between the actuation portion 22 of the beam and the substrate 16. The anchor provides a firm mechanical connection between the beam 18 and the substrate 16, as well as providing a rigid structure, from which the beam is cantilevered, and an electrical connection between the beam and the substrate. In the present embodiment, the anchor 12 is a first portion 28 of a signal line carrying some form of electrical signal and, therefore, is made of an electrically conductive material to allow it to carry the signal and transmit it into the beam 18 during operation of the switch. The substrate 16 can be, for example, a semiconductor wafer or portion thereof, including various layers of different semiconductor material (e.g., polysilicon, or single crystal silicon).

The tapered portion 20 of the beam includes a proximal end 30 and a distal end 32. The proximal end 30 is attached to the anchor 12, while the distal end 32 is attached to the actuation portion 22. The tapered portion 20 of the beam is vertically offset relative to the anchor 12 to provide a space 34 between the actuation portion 22 and the actuation electrode 26. The tapered portion 20 of the beam can be relatively thick (approximately 6 μm), and can be made of a highly conductive material such as gold, or combination of materials (e.g., a composite construction). The gap 34 between the actuation electrode 26 and the actuation portion of the beam generally is small (e.g., approximately 5 μm), although, in various embodiments, a greater or lesser gap can be used.

The actuation portion 22 is mounted to the distal end 32 of the tapered portion 20 of the beam. The actuation portion 22 is relatively wide compared to the tapered portion 20, to provide a greater area over which the force applied by the activation of the actuation electrode 26 can act. Since actuation force is proportional to the area of the actuation portion 22, the wider and longer actuation portion 22 of the beam causes a larger force to be applied to the beam when the actuation electrode 26 is activated, resulting in a faster switch response. Like the tapered portion 20, the actuation portion 22 also can be made of a highly conductive material or combination of materials.

A tip 24 is attached to the actuation portion 22 of the beam opposite from where the tapered portion 20 is attached. On the lower side of the tip 24 is a contact dimple 36, which functions to make contact with the electrode 29 when the cantilever beam 18 deflects in response to a charge applied to the actuation electrode 26. The tip 24 is vertically offset from the actuation area, much like the tapered portion 20 is offset vertically from the anchor 12; the vertical offset of the tip 24 relative to the actuation area 22 reduces capacitive coupling between the beam 18 and the second portion 29 of the signal line.

In operation of the switch 10, the anchor 12 is in electrical contact with, and forms part of, a first portion 28 of a signal line carrying an electrical signal. Opposite the first portion 28 of the signal line is a second portion 29 of the signal line. To activate the switch 10 and make the signal line continuous, such that a signal traveling down the first portion 28 of the signal line will travel through the switch 10 and into the second portion 29 of the signal line, the actuation electrode 26 is activated by inducing a charge in it. When the actuation electrode 26 becomes electrically charged, because of the small gap between the actuation electrode and the actuation portion 22 of the beam, the actuation portion of the beam is drawn toward the electrode such that the beam 18 deflects downward, bringing the contact dimple 36 in contact with the second electrode 29, thus completing the signal line and allowing a signal to pass from the first portion 28 of the signal line to the second portion 29 of the signal line.

The electronic components of MEMS can be fabricated using integrated circuit (IC) processes (e.g., CMOS or Bipolar processes), and can be patterned using photolithographic and etching methods for computer chip manufacture. The micromechanical components can be fabricated using compatible “micromachining” processes that selectively etch away parts of the silicon wafer or add new structural layers to form the mechanical and/or electromechanical components. Basic techniques in MEMS manufacture include depositing thin films of material on a substrate, applying a patterned mask on top of the films by some lithographic methods, and selectively etching the films. A thin film can be in the range of a few nanometers to 100 micrometers. Deposition techniques of use can include chemical procedures such as chemical vapor deposition (CVD), electrodeposition, epitaxy and thermal oxidation and physical procedures like physical vapor deposition (PVD) and casting. Methods for manufacture of nanoelectromechanical systems can also be used (see, e.g., Craighead, Science 290:1532-36, 2000).

In some embodiments, apparatus and/or detectors can be connected to various fluid filled compartments, for example microfluidic channels or nanochannels. These and other components of the apparatus can be formed as a single unit, for example, in the form of a chip (e.g. semiconductor chips) and/or microcapillary or microfluidic chips. Alternatively, individual components can be separately fabricated and attached together. Any material known for use in such chips can be used in the disclosed apparatus, including, for example, silicon (e.g., nanocrystalline silicon), silicon dioxide, polydimethyl siloxane (PDMS), polymethylmethacrylate (PMMA), plastic, glass, quartz, etc. As used herein, the term “nanocrystalline silicon” refers to silicon that comprises nanometer-scale silicon crystals, typically in the size range from 1 to 100 nanometers (nm). The term “porous silicon” refers to silicon that has been etched or otherwise treated to form a porous structure.

Techniques for batch fabrication of chips are well known in computer chip manufacture and/or microcapillary chip manufacture. Such chips can be manufactured by any method known in the art, such as by photolithography and etching, laser ablation, injection molding, casting, molecular beam epitaxy, dip-pen nanolithography, chemical vapor deposition (CVD) fabrication, electron beam or focused ion beam technology or imprinting techniques. Non-limiting examples include conventional molding, dry etching of silicon dioxide; and electron beam lithography. Methods for manufacture of nanoelectromechanical systems can be used for certain embodiments (see Craighead, supra, 2000.) Various forms of microfabricated chips are commercially available (e.g., Caliper Technologies Inc., Mountain View Calif.; ACLARA BioSciences Inc., Mountain View).

For fluid-filled compartments that can be exposed to various analytes, for example, nucleic acids, proteins and the like, the surfaces exposed to such molecules can be modified by coating, for example, to transform a surface from a hydrophobic to a hydrophilic surface and/or to decrease adsorption of molecules to a surface. Surface modification of common chip materials such as glass, silicon, quartz and/or PDMS is known (e.g., U.S. Pat. No. 6,263,286). Such modifications can include, for example, coating with commercially available capillary coatings (Supelco; Bellafonte Pa.), silanes with various functional (e.g. polyethyleneoxide or acrylamide, etc.).

In certain embodiments, such MEMS apparatus can be use to prepare nanocodes, to separate formed nanocodes from unincorporated components, to expose nanocodes or compositions containing the nanocodes (e.g., a molecular probe having an nanocode operably linked thereto) to targets, and/or to detect nanocodes bound to target molecules.

In other embodiments, kits are provided that include at least one (e.g., 1, 2, 3, 4, 5, etc.) or a plurality of nanocode(s), which can, but need not, be operably linked to a molecular probe, or can be in a form such that one or more conveniently can be operably linked to molecular probes comprising any of various chemical compositions (e.g., peptide molecular probes, nucleic acid molecular probes, etc.). As such, the nanocode(s) of the kit can contain a reactive group suitable for operably linking the nanocode to a particular type of molecular probe (e.g., a peptide molecular probe or a nucleic acid molecular probe), or the nanocodes can be in a form such that they can be modified such that, upon contact with the molecular probe and appropriate reagents, the nanocode is operably linked to the molecular probe. In one embodiment, the kit contains a plurality of different nanocodes, each of which can be operably linked to a molecular probe. In another embodiment, the nanocode(s) of the kit is (are) immobilized on a solid support, particularly in a form such that a molecular probe can be operably linked to the nanocode. In another embodiment, the kit contains a plurality of molecular probes (e.g., oligonucleotide probes such as a plurality of randomized oligonucleotides; ligands such as a plurality of receptor binding ligands; or antibodies such as a plurality of monoclonal antibodies each of which is specific for a target molecule), each probe of which is (or can be) operably linked to a particular nanocode.

In another embodiment of the invention, biomolecular probes, which include a molecular probe operably associated with a nanocode, are provided, wherein the molecular probe can specifically bind a biological material (target molecule). Also provided is a molecular identification assembly, which includes a nanocode, and a molecular probe operably associated with the nanocode. The molecular probe can be any molecular probe as disclosed herein or otherwise known in the art (e.g., a nucleic acid molecule or a polypeptide), and the nanocode can, but need not, further contain an operably linked object having a surface property detectable by SPM (e.g., a nanoparticle).

A plurality of molecular identification assemblies is provided, including a plurality of molecular identification assemblies in which two or more molecular identification assemblies of the plurality are the same or different. Molecular identification assemblies of a plurality can include same molecular probes operably linked to same nanocodes, same molecular probes operably linked to different nanocodes, different molecular probes operably linked to same nanocodes, different molecular probes operably linked to different nanocodes, and combinations thereof

In another embodiment, a molecular identification assembly, or each molecular identification assembly of a plurality, is immobilized onto a solid substrate (e.g., a chip, wafer, or bead). Where a plurality of molecular identification assemblies is immobilized on the solid substrate, they can be immobilized in an array, which can be an addressable array. An addressable array allows for conveniently practicing the methods of the invention in a high throughput format, wherein one or more, including all, steps of the method are performed automatically (e.g., using robotic devices that dispense and/or remove reagents from specified positions in the array at or after specified times, or that perform SPM to detect the surface property of a nanocode in a specified position). In another embodiment, the presence of multiple target molecules in a sample can be determined in a single (multiplex) reaction because different nanocodes linked to different molecular probes can be distinguishably detected.

A solid substrate provides a surface for immobilizing a nanocode and associated molecular probe, or performing a reaction. For example, the surface of the substrate can be modified to contain wells in which a reaction can be performed. Such modification can be performed, for example, using photolithography, stamping techniques, molding techniques or microetching techniques, the particular method being selected, for example, based on the composition and shape of the substrate. The surface of a substrate also can be modified to contain chemically derived sites that can be used to attach a molecular probe comprising an operably linked nanocode, or other material as desired, on the substrate. The addition of a pattern of chemical functional groups, such as amino groups, carboxy groups, oxo groups and thiol groups can be used to covalently attach molecules having the corresponding reactive functional groups or linker molecules, to which the desired molecules, in turn, can be bound.

The following examples are intended to illustrate but not limit the invention;

### EXAMPLE 1

### Synthesis of DNA-based Nanocodes

This example provides methods for synthesizing nanocode subunits and nanocode, and methods for modifying the subunits and nanocodes using tags such as gold particles and ferritin.

Precision Biology (PB) nanocode DNA structures were designed and prepared by scientists at Intel Precision Biology Group. Nanocodes were constructed from double stranded and branched DNA molecules derived from the pBK-CMV plasmid (Stratagene Corp., La Jolla Calif.; see FIG. 1). Each basic PB DNA structure was made up of 12 oligonucleotides that were synthesized by Operon Technologies, Inc. (Alameda Calif.). The oligonucleotides were preassembled (annealed) into 4 subunits (FIG. 2; 105, 110, 115, 120). After purification from agarose gel matrix, the subunits were assembled (ligated) into full length structures 100 (DNA based nanocodes). Each of the full length structures had 4 short branches 130 and 4 relatively longer branches 140, all with open ends. The basic full length nanocode structure was about 280 bp (90-100 nm; see FIG. 3). Several versions, including modified and linked versions of the basic nanocode structure, were constructed. Although the nanocodes are illustrated herein with spaces (gaps) in the “bottom strands” such that the relative positions of the subunits can be identified and to show positions in which additional oligonucleotides can be inserted (demonstrating the flexibility of the nanocodes), the subunits are fully ligatable and the bottom strands generally are ligated in full length nanocode structures.

Different versions of a nanocode structure, designated “PB2”, are shown in FIG. 3. Nanocode PB2A (200) contains short branches of 10 base pairs (bp; approx. 3.4 nm) each and long branches of 15 bp (approx. 5 nm) each (see FIG. 3A). A 10 nucleotide partial single stranded region was present in each of the “bottom” strands (indicated by the “loop” structure, “10 nt”, in FIG. 3A). Nanocode PB2B (210) was similar to PB2A, except that the loops were omitted and part of each of the long branches included a biotinylated 15 base peptide nucleic acid sequence (PNA; see FIG. 3B). Nanocode PB2C (220) was similar to PB2A, except that the loops were omitted and the length of the long branches was increased to 20 bp (approx. 7 nm; see FIG. 3C).

Modified versions of the PB2C nanocode containing non-DNA tags attached to the branches were constructed (designated “PB3”) as shown in FIG. 4 (see, also, Example 2). Nanocode subunits 305, 310, 315, and 320 were ligated to form nanocode 300, which contained shorter branches 330 and longer branches 340, wherein longer branches 340 contained a single stranded region (overhang). Nanoparticles 325, which were linked to oligonucleotides complementary to the single strand overhangs of longer branches 340, were annealed to nanocode 300 to generate nanoparticle-modified nanocode 350. For example, as shown in FIG. 4, a streptavidin-conjugated ferritin (Sigma) complex, wherein the streptavidin was bound to an oligonucleotide complementary to the single stranded portion of longer branches 340, was annealed to PB2C to generate “PB3-Fe”. Similarly, nanocode “PB3-g” was constructed by attaching nano-gold particles (1 nm or 5 nm) to PB2C via a sulfhydryl group (—SH) at the end of the DNA; and nanocode “PB3-B” was constructed by attaching streptavidin conjugated-gold to PB2B.

Nanocode XPB2, which containing two linked nanocode PB2 structures, was constructed as shown FIG. 5. Two new oligonucleotides (AT1p and PT10s; see FIG. 5) were introduced to obtain 2 variants of PB2, which were complementary to each other at one of their ends. After annealing and ligation of the modified PB2 nanocodes, the PB2ex nanocode formed a structure that was twice as large as the PB2 nanocode (approx. 200 nm).

Nanocode PB2ex was constructed as shown in FIG. 5 by extending the long branches of the base structure of nanocode PB2B (i.e., lacking the PNA portion) using oligonucleotides Br1, Br2, Br3 or Br4 (SEQ ID NO:4) and ABP (SEQ ID NO:5) in two ways. The long branches of PB2 were extended to 50 bp in PB2ex (approx 17 nm) to generate DPB2.

These results demonstrate that basic subunits can be constructed for use in generating a variety of nanocodes, which can be modified and/or further used as building blocks of additional nanocodes.

### EXAMPLE 2

### Scanning Probe Microscopy Imaging of Nanocodes

This example demonstrates that DNA based nanocodes can be detected using a scanning probe microscopy probe.

Scanning probe microscopy (SPM) was performed using a Digital Instruments Dimension™ 5000 instrument (VEECO Instruments; Fremont Calif.) and TappingMode™ imaging. Nanosensors™ Silicon non-contact cantilevers having a nominal frequency of about 300 kHz (corresponding to 125 μm long cantilevers) were used. Scan dimensions depended on the sample, and ranged nominally from 0.5 μm to 5 μm, with scan rates of 0.5 Hz to 1 Hz.

Control experiments examining imaging of different sized gold particles and different substrates were performed. Gold particles having sizes of 50 nm, 10 nm, 5 nm and 2 nm particles were purchased from Ted Pella, Inc. (Redding Calif.), and used as imaging controls on two different substrates, poly-L-lysine coated glass coverslips and 3-aminopropyltriethoxysilane (AP) treated mica (vapor phase silylation of freshly cleaved mica for 2 hr with 3-aminopropyltriethoxysilane). For the poly-L-lysine coated glass coverslips, 10 μl of gold colloidal solution was placed on the coverslips and allowed to dry. For the AP-mica substrate, 100 μl of gold colloidal solution was placed on the substrate for 15 min, then wicked off using a KIMWIPE tissue.

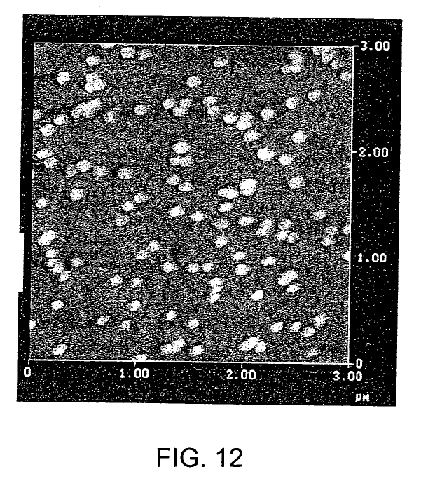

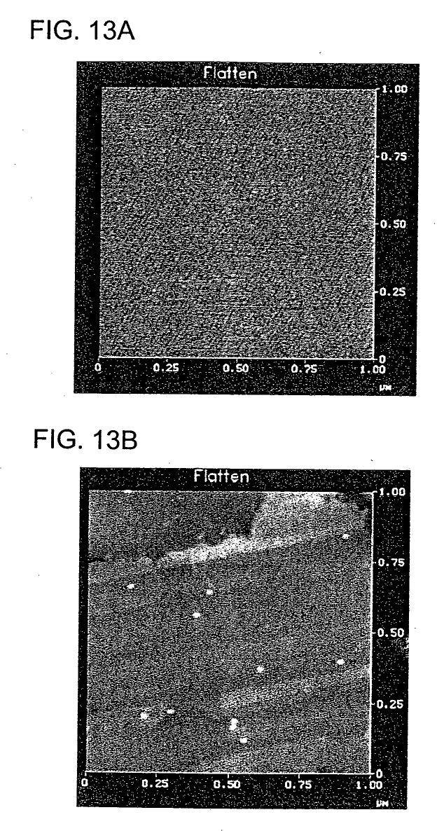

Atomic force microscopy (AFM) was performed using a poly-L-lysine coated coverslip (control), and on poly-L-lysine coated coverslips containing 50 nm gold nanoparticles, 10 nm gold nanoparticles, or 5 nm gold nanoparticles. In the control, features as high as 10 nm were observed. Poly-L-lysine was suitable for immobilization of 50 nm gold nanoparticles (see FIG. 12), whereas the 10 nm gold nanoparticles were found to have clustered after drying, and the 5 nm gold nanoparticles were undetectable due to the roughness of the surface. AFM of 3-aminopropyltriethoxysilane (AP) treated mica (control; FIG. 13A) also was examined and compared with AP-mica containing 50 nm, 10 nm (FIG. 13B), or 5 nm gold nanoparticles, or a mixture of 10 nm, 5 nm and 2 nm gold nanoparticles (see, also, Example 2). AFM was able to differentiate between 5 nm and 2 nm gold nanoparticles by height.

In another experiment, lambda-DNA (New England Biolabs, Inc.) was imaged as a control in AP-mica. Ten μl of lambda-DNA solution (10 ng/μl in 10 mM Tris-HCl, pH 8.0, 1 mM EDTA) was incubated on AP-mica for 15 min, then rinsed off gently with NANOPURE deionized (DI) water and blow-dried with N2. Imaging near the center of the DNA spot revealed that the concentration of DNA was too high, whereas imaging obtained at the edges of the spot, where alignment had occurred due to rinsing, revealed the lambda DNA structures.

These experiments demonstrate that AP-mica is a suitable substrate for resolving the sizes of nanostructures by SPM (e.g., 2 nm nanoparticles can be distinguished from 5 nm nanoparticles by height).

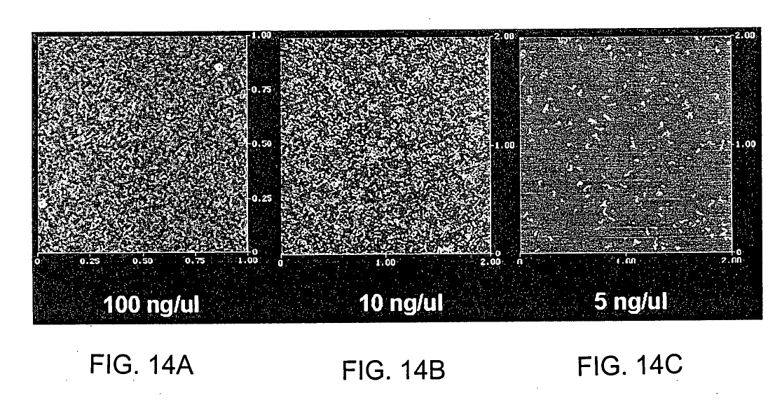

In order to optimize imaging of the nanocodes, various nanocodes, including tagged nanocodes, were placed on the AP-mica substrate under different conditions, and the samples were imaged. Ten μl of PB2C (see FIG. 3C) solution (100 ng/μl stock solution) was incubated on AP-mica for 15 min, then rinsed off gently with NANOPURE DI water, blow-dried with N2, and imaged. AFM revealed that this DNA concentration was too high, so different dilutions (100 ng/μl, 10 ng/μl, and 5 ng/μl) were prepared, and spotted and imaged. As shown in FIGS. 14A to 14C, spotting and imaging of the different dilutions of PB2C was very reproducible. AFM revealed that nanocode PB2 was imaged at 5 ng/μl.

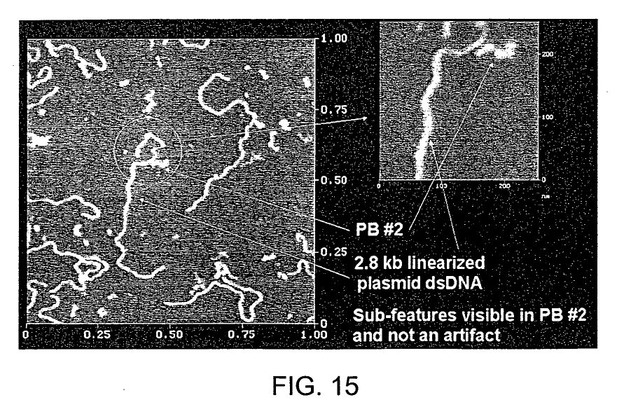

Following deposition of optimal concentrations of DNA solution, sub-features were observed in the strands of PB2C. In order to confirm that true sub-features were being detected, and not artifacts, a mixture of a 2.8 kb linearized plasmid double stranded DNA and PB2C was imaged. When the DNA solutions were premixed before deposition, the imaging did not yield good results, as the DNA tended to aggregate in some regions and was very sparse in other regions. To overcome this difficulty, the DNA solutions of linearized plasmid and PB2C were spotted alongside each other and the substrate was gently shaken for 10 sec to induce diffusion of smaller PB2C DNA. AFM imaging of the interface between nanocode PB2 and 2.8 kb linearized plasmid DNA revealed that sub-features of nanocode PB2 were clearly evident (FIG. 15, see inset), thus confirming that the results were not due to an artifact.

In another experiment, PB2C was intercalated with ethidium bromide to determine whether sub-features were enhanced. PB2C was intercalated with ethidium bromide (EtBr) at 1 μl (1 mg/ml concentration EtBr solution) DNA to 10 μl of PB2C stock solution (100 ng/μl). AFM images were obtained of nanocode PB2 intercalated with ethidium bromide, and sub-features were detected.

PB3-Fe was prepared by adding 2 μl of PB2C solution (100 ng/μl) to 2 μl of ferritin stock solution, and diluting it with 16 μl of 1×TE buffer (final concentration of PB3-Fe was 10 ng/μl). The solution was further diluted to 1 ng/μl, then 20 μl was incubated on AP-mica for 10 min, dipped and rinsed off gently in NANOPURE DI water, and blow-dried with N2. Different parts of the substrate were observed to have different concentrations of ferritin, DNA, and ferritin-labeled DNA (see FIG. 13). AFM images were obtained of AP-mica containing biotinylated nanocode PB2 on AP-mica, and of 1 ng/μl of nanocode PB-Fe (nanocode PB labeled with ferritin—see Example 1); unlabeled or partially labeled nanocode PB-Fe (Note—flattening of the image was difficult because the DNA is about 0.7 to 1 nm in height, whereas the ferritin is about 7.5 to 10 nm); and PB-Fe at different regions of the AP-mica substrate, including a close up view and a 3D view.

PB3-G was prepared by labeling PB2C, which contained biotin sites, with different sizes of gold (Au) particles. Different barcodes were synthesized by attaching 5 nm and 1 nm Au nanoparticles to PB2C (5115, 1551, etc.) to obtain PB3-G-5115, PB3-G-1551, etc. Initial imaging was performed on samples in which the ligation buffer contained dithiothreitol (DTT), and blind tests were performed with samples that were synthesized using ligation buffer that was free of DTT to determine whether DTT affected binding of the gold particles to the DNA nanocode. The stock solution of PB3-G (approx. 1.2 ng/μl) was diluted to different concentrations in 1×TE Buffer at dilutions of 1:5, 1:50 and 1:100. Images were obtained for PB3-G-5115 (synthesized with buffer containing DTT containing ligation buffer) at different dilutions, and, in blind test, in the absence of DTT. AFM imaging of nanocode PB3 5115 on AP-mica was obtained at a 1:5 dilution of a 1.2 ng/μl solution and at a 1:100 dilution of a 1.2 ng/μl solution, and of nanocode PB3 deposited on the substrate in the presence or absence of dithiothreitol. Although attachment and ligation appeared to be incomplete and the efficiency was low under either condition (with or without DTT), partially labeled strands of DNA at low concentrations along with the gold particles were imaged.

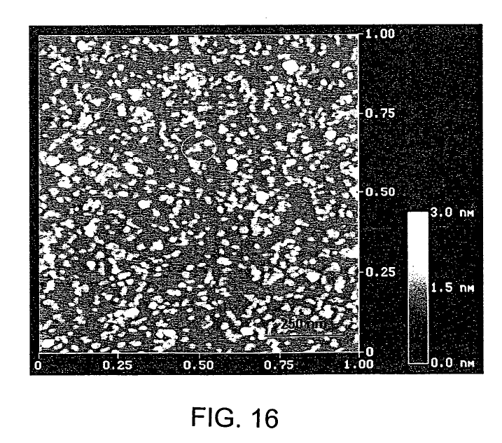

PB3-B was prepared by tagging PB2B with gold (Au) nanoparticles using a PNA based strategy. The stock solution of PB3B (approx. 3.5 ng/μl) was diluted to different concentrations in 1×TE buffer at dilutions of 1:5, 1:50 and 1:100, and imaged. AFM imaging of PB3B-G at a 1:100 dilution of a 3.5 ng/μl stock solution showed individual DNA strands that appeared to be partially labeled (FIG. 16). This result indicates that a low level of tagging and ligation efficiency were obtained using this approach.

PB2ex, which is a modified PB2 nanocode containing longer branches and different sub-features, was purified by gel isolation and imaged. One set of samples showed a high background, whereas a second set of samples had a clean background, though the images showed the DNA strands to be coiled.

These results demonstrate that imaging of DNA-based nanocodes can be optimized by varying the concentration of samples comprising the nanocodes and by varying the conditions used for depositing samples comprising the nanocodes on an imaging substrate.

### EXAMPLE 3

### Synthesis of Bubble Nanocodes

This example provides methods for producing nanocodes that contain bubbles having specified sizes in specified positions.

Nanocodes containing bubbles can be constructed of a single type of polymer or of different types of polymers (mosaic nanocodes). FIG. 6A illustrates a nucleic acid-peptide nucleic acid (PNA) mosaic nanocode containing bubbles in the PNA regions. A nucleic acid-PNA mosaic nanocode as exemplified in FIG. 6A is constructed by synthesizing the two strands, wherein the nucleic acid portions are complementary to each other (indicated by dotted lines; hydrogen bonds), and wherein one or more PNA portions contain, in the corresponding positions of the two strands, and in at least two positions in each strand, amino acid residues that can form a stable interstrand bond (e.g., cysteine residues, which can form disulfide bonds).

To construct a mosaic nanocode containing bubbles as shown in FIG. 6A, two polymer chains are made that are linear mosaic structure comprising nucleic acid and peptide sequences. The two chains are allowed to anneal to form a double stranded structure due to the complementarity of the nucleic acid portions of the strands. The peptide regions can form disulfide bonds to stabilize the double stranded regions. The nucleic acid regions are larger in diameter than the peptide regions. Various lengths of the nucleic acid regions and the peptide regions can be made in one structure, according to design. Several double stranded structures can be joined to form a larger nanocode structure. The sizes and/or lengths of the substructures are used as code elements. A nanocode made by this method can be conjugated to a probe that recognizes a target molecule. Upon contacting a nanocode comprising a probe with a target molecule recognized by the probe, the nanocode can be read by SPM, and the signal change in the probe due to target-probe binding indicates the presence of the target molecule, and the nanocode information associated with the complex indicates the nature of the target molecule.

To construct a nanocode containing bubbles, and that is composed of a single type of polymer such as a nucleic acid as exemplified in FIG. 6B, two nucleic acid chains are made that contain complementary regions and non-complementary regions. The two chains are allowed to anneal to form a double stranded structure via the complementary regions. The partial single stranded regions are hybridized to additional nucleic cid fragments, which are complementary to the single stranded regions, to form partial tetra-stranded regions, which are larger in diameter than the double stranded regions. Various lengths of the nucleic acid regions, including the complementary regions and the non-complementary regions, can be made in a single structure, according to design. Several of such structures can be joined to form a larger nanocode structure. The lengths of the substructures (double stranded regions and tetra-stranded regions) are used as code elements. A nanocode made by this method can be conjugated to a probe that recognizes a target molecule. Upon contacting a nanocode comprising a probe with a target molecule recognized by the probe, the nanocode can be read by SPM, and the signal change in the probe due to target-probe binding indicates the presence of the target molecule, and the nanocode information associated with the complex indicates the nature of the target molecule.

### EXAMPLE 4

### Synthesis of Branched Nanocodes

This example provides methods for producing nanocodes that contain branches having specified sizes in specified positions.

To construct a branched nanocode as exemplified in FIG. 7A, several subparts of double stranded nucleic acids are assembled from synthetic oligonucleotides. Each subpart has more than two ligatable ends. Some of the ends are used to extend the length of the nanocode structure and the rest are used to extend the branches. A complete length of nanocode structure is built by joining several subparts by complementary sticky (ligatable) ends. Branches are extended by ligating short nucleic acid fragments. The lengths and/or relative distances of the branches are used as code elements. A nanocode made by this method can be conjugated to a probe that recognizes a target molecule. Upon contacting a nanocode comprising a probe with a target molecule recognized by the probe, the nanocode can be read by SPM, and the signal change in the probe due to target-probe binding indicates the presence of the target molecule, and the nanocode information associated with the complex indicates the nature of the target molecule.

To construct a modified branched nanocode as exemplified in FIG. 7B, several subparts of double stranded nucleic acids are assembled from synthetic oligonucleotides. Each subpart has more than two ligatable ends. Some of the ends are used to extend the length of the nanocode structure and the rest are used to extend the branches. A complete length of nanocode structure is built by joining several subparts by complementary sticky (ligatable) ends. Branches can be extended by ligating short nucleic acid fragments. The nanocode can be modified by attaching an object to the branch site, for example, an object linked to an oligonucleotide that hybridizes to a ligatable end of a branch. The object can be an inorganic particle such as a metal, a semiconductor, etc., or can be an organic particle such as latex, polystyrene, a polypeptide, etc. The sizes and/or relative distances of the objects are used as code elements. A nanocode made by this method can be conjugated to a probe that recognizes a target molecule. Upon contacting a nanocode comprising a probe with a target molecule recognized by the probe, the nanocode can be read by SPM, and the signal change in the probe due to target-probe binding indicates the presence of the target molecule, and the nanocode information associated with the complex indicates the nature of the target molecule.

Additional nanocodes can be constructed by combining the methods described in Examples 1 to 4, for example, to produce nanocodes containing bubbles and branches.

Although the invention has been described with reference to the above example, it will be understood that modifications and variations are encompassed within the spirit and scope of the invention. Accordingly, the invention is limited only by the following claims.

What is claimed is:

1. A method to identify a molecular probe, comprising:
contacting a molecular probe comprising a nanocode having a surface property with a scanning probe microscopy (SPM) probe, wherein the nanocode comprises
a) a mosaic biomolecule comprising a nucleic acid and a polypeptide,
b) a nucleic acid molecule comprising regions of differing strandedness;
c) a branched nucleic acid molecule; or
d) a nucleic acid molecule comprising an object that affects the surface property of the nanocode,
and detecting the surface property of the nanocode, thereby identifying the molecular probe.

2. The method of claim 1, wherein the nanocode comprises a mosaic biomolecule comprising a polypeptide region bound on each terminus to a flanking nucleic acid molecule, and
wherein a code of the nanocode is determined by detecting sizes of the polypeptide region, a flanking nucleic acid molecule, or the polypeptide region and the flanking nucleic acid molecules.

3. The method of claim 1, wherein the nanocode comprises a mosaic biomolecule comprising a polypeptide region bound on each terminus to a flanking nucleic acid molecule, and
wherein a code of the nanocode is determined by detecting lengths of the polypeptide region, or a flanking nucleic acid molecule, or the polypeptide region and the flanking nucleic acid molecules.

4. The method of claim 1, wherein the nanocode comprises a mosaic biomolecule comprising a polypeptide region bound on each terminus to a flanking nucleic acid molecule, and
wherein a code of the nanocode is determined by detecting sizes and lengths of the polypeptide region, or a flanking nucleic acid molecule, or the polypeptide region and the flanking nucleic acid molecules.

5. The method of claim 1, wherein the nanocode comprises a mosaic biomolecule comprising a nucleic acid molecule bound to a polypeptide, and
wherein a code of the nanocode is identified by detecting the position of the polypeptide in the nanocode, and a size of the polypeptide in the nanocode.

6. The method of claim 1, wherein the nanocode comprises a nucleic acid molecule comprising regions of differing strandedness, and
wherein a code of the nanocode is determined by detecting lengths of regions of differing strandedness.

7. The method of claim 1, wherein the nanocode comprises a branched nucleic acid molecule, and
wherein a code of the nanocode is determined by detecting positions, or lengths, or positions and lengths of branches in the branched nucleic acid molecule.

8. The method of claim 7, wherein the branched nanocode is constructed by obtaining a nucleic acid template comprising a container section and a probe section; and
hybridizing one or more oligonucleotides to the container section to create a nanocode.

9. The method of claim 8, wherein the oligonucleotides are associated with an object that affects the surface property of the nanocode, and
wherein a code of the nanocode is determined by detecting sizes, positions, or sizes and positions of the objects on the nanocode.

10. A method of detecting a target molecule, comprising:
a) contacting a sample with a molecular probe comprising a nanocode having a surface property, under conditions suitable for specific binding of the molecular probe to the target molecule, when present, wherein the nanocode comprises:
i) a mosaic biomolecule comprising a nucleic acid bound to a polypeptide,
ii) a nucleic acid molecule comprising regions of differing strandedness;
iii) a branched nucleic acid molecule; and
iv) a nucleic acid molecule comprising an object that affects the surface property of the nanocode; and
b) detecting specific binding of the nanocode by scanning probe microscopy (SPM),
thereby detecting the target molecule.

11. The method of claim 10, wherein the target molecule is a biomolecule.

12. The method of claim 10, wherein detecting specific binding of the nanocode comprises detecting a change in an SPM probe signal as compared with an SPM probe signal in the absence of the target molecule.

13. The method of claim 12, wherein detecting specific binding of the nanocode identifies the target molecule.

14. The method of claim 10, wherein the target molecule is a protein, a peptide, a glycoprotein, a lipoprotein, a prion, a nucleic acid, a polynucleotide, an oligonucleotide, a lipid, a fatty acid, a carbohydrate, a glycolipid, a phospholipid, a sphingolipid, a lipopolysaccharide, a polysaccharide, a eukaryotic cell, a prokaryotic cell, a bacterium, a phage, a virus, or a pathogen.

15. The method of claim 10, wherein the sample comprises a biological sample.

16. The method of claim 15, wherein the biological sample is obtained from a subject.

17. The method of claim 10, further comprising identifying the code of the nanocode.

18. The method of claim 10, wherein detecting specific binding of the nanocode by SPM comprises detecting a signal indicative of the nanocode.

19. The method of claim 18, wherein the signal indicative of the nanocode is transmitted to a processor.

20. The method of claim 18, wherein the signal is transmitted through a micro-electromechanical system (MEMS) switch.

21. A biomolecular probe, comprising a molecular probe operably associated with a nanocode comprising one or more of:
a) a mosaic biomolecule comprising a nucleic acid bound to a polypeptide,
b) a nucleic acid molecule comprising regions of differing strandedness;
c) a branched nucleic acid molecule; and
d) a nucleic acid molecule comprising an object that affects the surface property of the nanocode,
wherein the nanocode identifies the molecular probe.

22. The biomolecular probe of claim 21, wherein the molecular probe comprises a polynucleotide or a polypeptide.

23. The biomolecular probe of claim 22, wherein the polypeptide comprises an antibody or an antigen binding fragment of an antibody.

24. The biomolecular probe of claim 21, wherein the nanocode comprises a mosaic biomolecule comprising a nucleic acid molecule bound to a polypeptide.

25. The biomolecular probe of claim 21, wherein the nanocode comprises a polypeptide region bound on each terminus to a flanking nucleic acid molecule.

26. The biomolecular probe of claim 25, wherein the polypeptide region comprises at least five amino acid residues.

27. The biomolecular probe of claim 25, wherein the polypeptide region comprises at least ten amino acid residues.

28. The biomolecular probe of claim 25, wherein the flanking nucleic acid molecules comprise at least five nucleotides.

29. The biomolecular probe of claim 25, wherein the flanking nucleic acid molecules comprise at least ten nucleotides.

30. The biomolecular probe of claim 21, wherein the nanocode comprises a nucleic acid molecule comprising regions of differing strandedness.

31. The biomolecular probe of claim 30, wherein the nanocode comprises a double-stranded nucleic acid region and a tetra-stranded region.

32. The biomolecular probe of claim 30, wherein the nanocode comprises a tetra-stranded nucleic acid region comprising at least ten nucleotides in length.

33. The biomolecular probe of claim 30, wherein the nanocode comprises a plurality of tetra-stranded nucleic acid regions.

34. The biomolecular probe of claim 21, wherein the nanocode comprises a branched nucleic acid molecule.

35. The biomolecular probe of claim 34, wherein the nanocode comprises a nucleic acid molecule having multiple branches.

36. The biomolecular probe of claim 21, wherein the nanocode comprises a nucleic acid molecule comprising an object that affects the surface property of the nanocode.

37. The biomolecular probe of claim 36, wherein the nanocode comprises a branched nucleic acid molecule comprising two or more objects.

38. The biomolecular probe of claim 36, wherein the nanocode comprises a mosaic biomolecule comprising a nucleic acid bound to a polypeptide.

39. The biomolecular probe of claim 36, wherein the nanocode comprises a nucleic acid molecule comprising regions of differing strandedness.

40. The biomolecular probe of claim 30, wherein the nanocode comprises a single-stranded or double-stranded nucleic acid region and a tetra-stranded nucleic acid region.

41. A molecular identification assembly, comprising:
a) a nanocode having a surface property detectable by scanning probe microscopy, wherein the nanocode comprises
i) a mosaic biomolecule comprising a nucleic acid and a polypeptide,
ii) a nucleic acid molecule comprising regions of differing strandedness;
iii) a branched nucleic acid molecule; or
iv) a nucleic acid molecule comprising an object that affects the surface property of the nanocode; and
b) a molecular probe operably associated with the nanocode.

42. The molecular identification assembly of claim 41, wherein the molecular probe comprises a nucleic acid molecule or a polypeptide.

43. The molecular identification assembly of claim 41, wherein the nanocode further comprises an operably linked object detectable by scanning probe microscopy.

44. The molecular identification assembly of claim 43, wherein the object comprises a nanoparticle.

45. The molecular identification assembly of claim 41, which comprises one of a plurality of molecular identification assemblies.

46. The molecular identification assembly of claim 45, wherein at least two molecular identification assemblies of the plurality are different.

47. The molecular identification assembly of claim 46, wherein the molecular probes of different molecular identification assemblies are different.

48. The molecular identification assembly of claim 46, wherein the nanocodes of different molecular identification assemblies are different.

49. The molecular identification assembly of claim 41, which is immobilized on a solid substrate.

50. The molecular identification assembly of claim 49, wherein each of a plurality of molecular identification assemblies is immobilized on a solid substrate.

51. The molecular identification assembly of claim 50, wherein the molecular identification assemblies are immobilized in an array.

52. A molecular characterization system, comprising
a) a reaction chamber, which can contain at least one sample, and
b) at least one molecular probe operably linked to a nanocode.

53. The molecular characterization system of claim 52, wherein the reaction chamber comprises a substrate, which can contain the sample.

54. The molecular characterization system of claim 53, wherein the substrate can contain a plurality of sample.

55. The molecular characterization system of claim 52, which comprises a plurality of molecular probes, wherein each molecular probe of the plurality is operably linked to a nanocode.

56. The molecular characterization system of claim 52, further comprising, operatively coupled to the reaction chamber, a scanning probe microscopy (SPM) probe to detect the nanocode and generate a signal indicative of the nanocode.

57. The molecular characterization system of claim 56, further comprising, operatively coupled to the SPM probe, a processor to process the signal generated by the SPM probe.

58. The molecular characterization system of claim 57, further comprising, operatively coupled to the SPM probe, a micro-electromechanical system (MEMS) switch to transmit the signal generated by the SPM probe to the processor.

59. An apparatus, comprising
a) a substrate, which comprises a molecular probe operably linked a nanocode;
b) a scanning probe microscopy (SPM) probe, which can detect a surface property of the nanocode, wherein the SPM probe is in operable association with the substrate and can generate a signal indicative of the surface property of the nanocode; and
c) a detector operably coupled to the SPM probe, wherein the detector provides a signal representative of a surface property of the nanocode.

60. The apparatus of claim 59, wherein the nanocode comprises:
a) a mosaic biomolecule comprising a nucleic acid bound to a polypeptide,
b) a nucleic acid molecule comprising regions of differing strandedness;
c) a branched nucleic acid molecule; or
d) a nucleic acid molecule comprising an object that affects the surface property of the nanocode.

61. The apparatus of claim 59, further comprising, operatively coupled to the SPM probe, a processor to process the signal generated by the SPM probe.

62. The apparatus of claim 59, further comprising, operatively coupled to the SPM probe, a micro-electromechanical system (MEMS) switch to transmit the signal generated by the SPM probe to the detector.


SEQUENCE LISTING (12 sequences)

SEQ ID NO: 1 - DNA, 310 bp, Artificial sequence
  Synthetic construct
ttgggtacacttacctggtaccccacccgggtggaaaatcgatgggcccgcggccgctctagaagtactctcgagaagctttttgaattctttggatccactagtgtcgacctgcaggcgcgcgagctccagcttttgttccctttagtgagggttaatttcgagcttggcgtaatcaaggtcatagctgtttcctgtgtgaaattgttatccgctcacaattccacacaatatacgagccggaagtataaagtgtaaagcctggggtgcctaatgagtgagctaactcacagtaattgcggctagcgga

SEQ ID NO: 2 - DNA, 21 bp, Artificial sequence
  Primer
ttgggtacacttacctggtac

SEQ ID NO: 3 - DNA, 22 bp, Artificial sequence
  Primer
tccgctagccgcaattactgtg

SEQ ID NO: 4 - DNA, 45 bp, Artificial sequence
  Synthetic construct
cttgatcgatcggatcgagctctcgatcgccagtctcattccgcc

SEQ ID NO: 5 - DNA, 30 bp, Artificial sequence
  Synthetic construct
gcgatcgagagctcgatccgatcgatcaag

SEQ ID NO: 6 - DNA, 44 bp, Artificial sequence
  Synthetic construct
cttgatcgatcggatcgagctctcgatcgccgaatggcagaagt

SEQ ID NO: 7 - DNA, 45 bp, Artificial sequence
  Synthetic construct
cttgatcgatcggatcgagctctcgatcgctgtgccattgtccgc

SEQ ID NO: 8 - DNA, 45 bp, Artificial sequence
  Synthetic construct
cttgatcgatcggatcgagctctcgatcgctggtctagtcagcaa

SEQ ID NO: 9 - DNA, 11 bp, Artificial sequence
  Synthetic construct Nucleic acid-peptide mosaic
ccaccttgccc

SEQ ID NO: 10 - DNA, 10 bp, Artificial sequence
  Synthetic construct Nucleic acid-peptide mosaic
gtgtgtgtgt

SEQ ID NO: 11 - DNA, 10 bp, Artificial sequence
  Synthetic construct Nucleic acid-peptide mosaic
tctctctctc

SEQ ID NO: 12 - DNA, 11 bp, Artificial sequence
  Synthetic construct Nucleic acid-peptide mosaic
gggcaaggagg